(19) United States
(12) Patent Application Publication
(10) Pub. No.: US 2026/0291891 A1
(43) Pub. Date: Sep. 24, 2026

(54) SYSTEM

(71) Applicant: SoftBank Group Corp., Tokyo (JP)

(72) Inventor: Ayaka KAWABE, Tokyo (JP)

(73) Assignee: SoftBank Group Corp., Tokyo (JP)

(21) Appl. No.: 19/567,413

(22) Filed: Mar. 16, 2026

(30) Foreign Application Priority Data
Mar. 19, 2025 (JP) 2025-045085

(51) Int. Cl. H04L 51/02; G06N 3/0475

(52) U.S. Cl. CPC H04L 51/02; G06N 3/0475

(57) ABSTRACT

A system includes a processor that is configured to receive a voice input from a user and convert the voice input into text data by using natural language processing, analyze a photograph or a video to extract information from the photograph or the video, and recognize an emotional state of the user and transmit a prompt sentence to a generative artificial intelligence model.

### CROSS-REFERENCE TO RELATED APPLICATION

This application is based on and claims priority under 35 USC 119 from Japanese Patent Application No. 2025-045085 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information processing systems typically handle voice recognition, image or video analysis, user state estimation, and schedule management as separate and independent functions, often distributed across multiple applications or services. As a result, the user must manually switch between different applications, provide the same information repeatedly, and manage fragmented data and preferences, which increases the operational burden and reduces overall usability. Furthermore, known systems often fail to sufficiently recognize and utilize the emotional state, behavior history, and habits of the user when generating responses or providing support, thereby limiting the degree of personalization and the quality of support. In addition, existing systems do not adequately integrate a generative artificial intelligence model with multimodal inputs such as voice, images, and videos in a unified processing framework, which makes it difficult to provide context-aware, consistent, and adaptive outputs. Therefore, there is a need for a system that centrally receives and processes a user's voice input and media content, recognizes the user's emotional state, learns the user's behavior history and habits, manages the user's schedule including reminders, and cooperates with a generative artificial intelligence model so as to provide personalized and integrated assistance.

### SUMMARY

In order to solve the above-described problems, a system according to one embodiment of the present invention comprises a processor, wherein the processor is configured to receive a voice input from a user and convert the voice input into text data by using natural language processing, analyze a photograph or a video to extract information from the photograph or the video, and recognize an emotional state of the user and transmit a prompt sentence to a generative artificial intelligence model. The processor is further configured to learn a behavior history and habits of the user and optimize each function of the system based on the learned behavior history and habits of the user, and to manage a schedule of the user and perform notification by using a reminder function. By integrating voice recognition, image and video analysis, emotional state recognition, user behavior learning, generative artificial intelligence prompting, and schedule management including reminders in a single processor-controlled system, the system can provide unified and context-aware support tailored to the user, thereby reducing the operational burden on the user and improving the quality and personalization of the assistance.

The term “system” refers to an information processing apparatus including at least one processor and associated hardware and software components configured to execute the functions described in the claims.

The term “processor” refers to one or more hardware processing units, such as a central processing unit (CPU), a graphics processing unit (GPU), a digital signal processor (DSP), or any combination thereof, capable of executing instructions to implement the functions described in the claims.

The term “voice input” refers to audio data representing speech uttered by a user and captured by a microphone or another audio input device.

The term “user” refers to a human operator who provides inputs to the system, such as voice inputs, photographs, or videos, and who receives outputs or services from the system.

The term “text data” refers to a sequence of characters or symbols representing linguistic content obtained by converting a voice input or other data into a machine-readable text format.

The term “natural language processing” refers to a set of computational techniques for analyzing, understanding, or generating human language, including at least speech recognition, language modeling, tokenization, parsing, semantic analysis, or intent detection.

The term “photograph” refers to a still image captured by a camera or generated by an image capture device, regardless of the format or resolution.

The term “video” refers to moving image data comprising a sequence of frames, optionally including associated audio, captured by a camera or generated by an image capture device.

The term “analyze a photograph or a video” refers to processing image or video data to detect, recognize, classify, or extract information such as objects, scenes, text, faces, actions, or other features.

The term “information” refers to data, attributes, features, labels, or metadata derived from analyzing a photograph or a video and usable by the system for subsequent processing or decision-making.

The term “emotional state” refers to a psychological or affective condition of the user, such as happiness, sadness, anger, surprise, fear, or a level of stress or calmness, estimated by the system based on one or more types of user data.

The term “recognize an emotional state” refers to inferring or estimating the emotional state of the user by processing data such as voice characteristics, facial expressions, linguistic content, physiological signals, or interaction patterns.

The term “generative artificial intelligence model” refers to a machine learning model configured to generate text, audio, images, or other content based on an input prompt, including but not limited to large language models, text-to-image models, and multimodal generative models.

The term “prompt sentence” refers to a text string or structured textual instruction transmitted to a generative artificial intelligence model to cause the generative artificial intelligence model to produce a response or output.

The term “behavior history” refers to records of past actions or interactions of the user with the system or with related services, including but not limited to requested functions, accepted recommendations, and usage frequency.

The term “habits” refers to patterns or tendencies in the behavior history of the user that are identified by the system, such as typical usage times, preferred content types, or recurring choices.

The term “learn a behavior history and habits” refers to analyzing and modeling the behavior history of the user over time, using methods such as statistical analysis or machine learning, to extract and update information about the user's habits and preferences.

The term “optimize each function of the system” refers to adjusting parameters, selection criteria, processing flows, or output formats of individual functions of the system based on the learned behavior history and habits of the user to improve relevance, efficiency, or user satisfaction.

The term “schedule” refers to a set of time-based entries associated with the user, each entry including at least a time or date and optionally additional information such as a title, location, or description of an event or task.

The term “manage a schedule” refers to creating, storing, updating, deleting, retrieving, or presenting schedule entries for the user.

The term “reminder function” refers to a function for generating and providing notifications or alerts to the user at a specified time or in association with a schedule entry.

The term “perform notification” refers to outputting a reminder or alert to the user through at least one modality, such as audio output, visual display, vibration, or a message, based on the reminder function.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

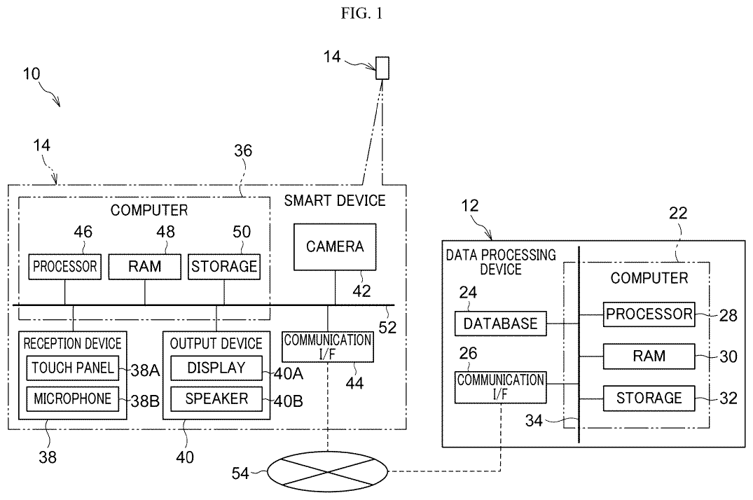

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

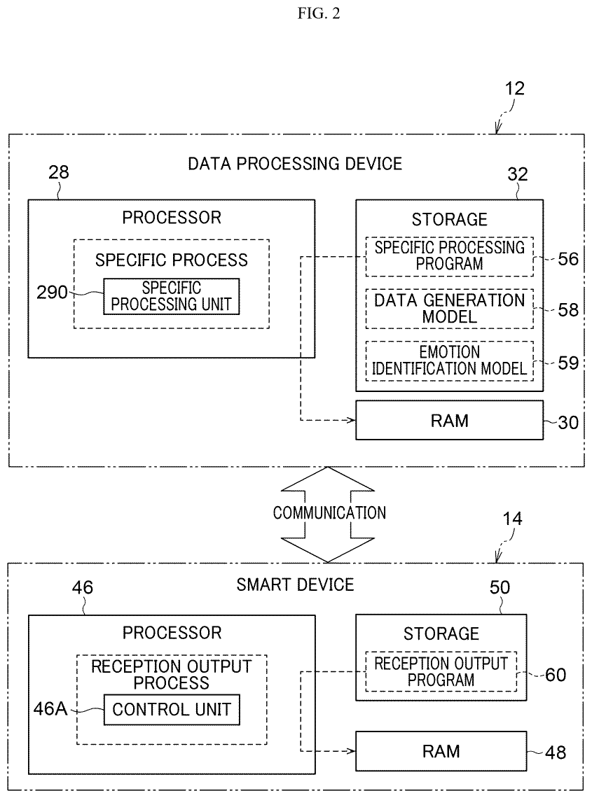

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional interactive information processing systems that support multiple functions such as schedule management, travel planning, meal recommendation, text correction, and image analysis often implement each function as an independent application or service. In such systems, a server typically receives user input, dispatches the input to a fixed function based on simple keyword matching or menu selection, and returns canned responses. As a result, these systems suffer from several technical problems.

First, existing systems exhibit limited accuracy and robustness when handling heterogeneous input modalities such as speech, text, and images. Voice recognition errors, inconsistent normalization, and lack of context-aware correction cause downstream components to receive noisy textual data, which degrades intent classification, module selection, and final response quality. This leads to increased processing retries, error handling overhead, and inefficient utilization of computational resources in the server.

Second, many systems rely on static, rule-based dispatch logic to select a particular functional module. Such logic does not effectively capture nuanced user intent, especially in natural language instructions that may simultaneously relate to scheduling, traveling, and dining preferences. This results in frequent misrouting of requests, redundant calls to external services, and the need for manual disambiguation. These behaviors increase processing latency, network usage, and server load, thereby reducing overall throughput and responsiveness.

Third, conventional architectures treat generative artificial intelligence models as simple text generators that are loosely coupled to the rest of the processing pipeline. In many cases, a generative model is invoked with ad-hoc input text, without a consistent structure or machine-readable context that would allow the model to generate responses tailored to the precise output of the underlying functional modules. This ad-hoc invocation prevents efficient reuse of intermediate data, causes the model to hallucinate missing details, and requires more tokens and computation than necessary for each response.

Fourth, feedback from the user is rarely integrated into the low-level technical behavior of the system. Even when systems collect ratings or comments, such data is typically used only for business analytics rather than for adaptively updating the intent determination logic, the function selection logic, or the construction of prompts for the generative model. Without such integration, errors and inefficiencies in the processing pipeline persist over time, and the system fails to achieve long-term optimization of module invocation patterns, response generation behavior, and resource allocation.

Fifth, conventional prompt construction for generative models is often manual, task-specific, and not systematically derived from structured outputs of upstream modules. As a result, the generated responses may include extraneous or missing information, and the server may need to perform multiple regeneration attempts, which increases latency and computation cost. There is no standardized mechanism to couple structured data (such as normalized schedule entries, ranked travel options, or filtered recipe data) with natural-language instructions in a way that the generative model can reliably transform into concise and accurate responses.

Accordingly, there is a need for an improved computer-implemented system that (i) reliably converts and normalizes user inputs from multiple modalities into consistent textual representations, (ii) performs accurate and adaptive intent determination and function selection, (iii) integrates structured outputs from internal and external processing units into systematically generated prompt sentences, (iv) invokes a generative artificial intelligence model in a controlled and resource-efficient manner, and (v) accumulates user evaluation data to automatically refine intent determination, function selection, and prompt generation logic over time. Such a system should technically improve the operation of servers and associated information processing devices by reducing misclassification, avoiding unnecessary service calls, lowering end-to-end latency, stabilizing response quality, and enabling data-driven self-optimization of the overall processing pipeline.

The specific processing by the specific processing unit 290 of the data processing device 12 in Example 1 is realized by the following means.

The present invention provides a server comprising a processor configured to receive, from a terminal, user voice information or character information, convert the user voice information into character information by using voice recognition processing and character string processing, and normalize and correct an error of the character information; analyze the character information and image information to extract intent information indicating a usage purpose and target information, and select at least one function from among a schedule management function, a movement plan presentation function, a meal proposal function, a character correction function, and an image analysis function based on the intent information; generate and transmit inquiry data to an external information processing unit or an internal information processing unit according to the selected function, acquire processing result data including at least one of schedule information, movement information, meal information, character information, and image analysis information, and aggregate the processing result data into structured data of a predetermined format; generate a prompt sentence to be input to a generative artificial intelligence model based on a user request content and the structured data, transmit the prompt sentence to the generative artificial intelligence model, and acquire a response sentence expressed in natural language from the generative artificial intelligence model; generate output information for the terminal based on the response sentence, and transmit at least one of display information and voice synthesis information to the terminal; and store evaluation information and response history information obtained from a user as learning data, and update at least one of processing of determining the intent information and processing of selecting the function based on the learning data. This enables the server to implement a unified and adaptive processing pipeline that (i) improves the accuracy and robustness of user input interpretation by combining normalization and error correction with intent-aware analysis, (ii) dynamically routes each request to an appropriate functional module and external or internal information processing unit while minimizing unnecessary calls, (iii) automatically transforms structured module outputs into machine-generated prompt sentences optimized for the generative artificial intelligence model, (iv) generates stable and concise natural-language responses with reduced processing latency and resource usage, and (v) continuously refines intent determination, function selection, and prompt generation behavior based on accumulated learning data, thereby improving the overall technical performance and efficiency of the interactive information processing system.

The term “processor” refers to a hardware or hardware-implemented processing unit, including one or more central processing units, graphics processing units, digital signal processors, or other computation units, configured to execute instructions and perform the described information processing operations.

The term “terminal” refers to an information processing device operated by a user, including but not limited to a portable communication device, a stationary computing device, or any input/output device capable of capturing user input and presenting output information.

The term “user voice information” refers to audio data representing speech uttered by a user and captured by an audio input unit of the terminal.

The term “character information” refers to data expressed as a sequence of characters, including letters, numbers, symbols, or control codes, which represent linguistic content or other textual information.

The term “voice recognition processing” refers to processing that converts user voice information into character information, including acoustic analysis, pattern matching, and language modeling.

The term “character string processing” refers to processing applied to character information, including segmentation, tokenization, encoding, decoding, and format conversion.

The term “normalize” refers to processing that transforms character information into a consistent representation, including unifying character types, adjusting case or spacing, and standardizing punctuation.

The term “correct an error of the character information” refers to processing that detects and repairs inaccuracies in character information, including grammar errors, spelling errors, and recognition errors, while preserving an intended meaning.

The term “image information” refers to data representing a still image or a moving image, including pixel data, compressed image streams, or encoded frame sequences.

The term “intent information” refers to data representing an inferred purpose or objective of a user request, obtained by analyzing character information and/or image information.

The term “target information” refers to data representing one or more objects, entities, time periods, locations, or other subjects that are relevant to the intent information.

The term “schedule management function” refers to a processing function that acquires, updates, or presents schedule information, including event data, appointment data, or reminder data associated with a user.

The term “movement plan presentation function” refers to a processing function that generates or selects one or more movement or travel plans, including transportation routes, departure times, destinations, or related itinerary information.

The term “meal proposal function” refers to a processing function that generates or selects one or more meal options, including menu items, recipes, or dietary recommendations, based on user conditions or constraints.

The term “character correction function” refers to a processing function that modifies character information to improve correctness, clarity, or style, without substantially altering an original user intent.

The term “image analysis function” refers to a processing function that extracts feature information from image information, including detected objects, labels, text regions, or other structured analysis results.

The term “external information processing unit” refers to an information processing resource or service located outside the server, including a remote server, a cloud service, or an external application programming interface.

The term “internal information processing unit” refers to an information processing resource or component located within the server, including an internal module, library, or database engine, that performs data processing without external network communication.

The term “inquiry data” refers to data generated for requesting processing by an external information processing unit or an internal information processing unit, including parameters, filters, identifiers, and other control information.

The term “processing result data” refers to data returned from an external information processing unit or an internal information processing unit in response to inquiry data, including schedule information, movement information, meal information, character information, and image analysis information.

The term “structured data” refers to data organized according to a predetermined format, such as a table, a record set, or a hierarchical structure, in which fields and relationships are explicitly defined.

The term “predetermined format” refers to a predefined specification for arranging and encoding structured data, including field names, data types, and relationships between data elements.

The term “user request content” refers to information representing a semantic meaning of a user request, derived from user voice information or character information after conversion, normalization, and analysis.

The term “prompt sentence” refers to character information constructed for input to a generative artificial intelligence model, the character information including instructions, context, and data necessary to cause the model to generate a desired response sentence.

The term “generative artificial intelligence model” refers to an information processing model that, upon receiving a prompt sentence, generates new character information or other data by probabilistic or learned inference based on training data.

The term “response sentence” refers to character information generated by a generative artificial intelligence model in response to a prompt sentence and intended to be presented to a user.

The term “output information for the terminal” refers to data generated for presentation to a user via the terminal, including the response sentence and associated control or formatting information.

The term “display information” refers to data used to present visual content on a display unit of the terminal, including text strings, layout information, and graphical attributes.

The term “voice synthesis information” refers to data used by a speech synthesis engine to generate audio representing spoken content derived from a response sentence.

The term “evaluation information” refers to data representing feedback from a user regarding a response sentence or system behavior, including ratings, selection operations, or explicit evaluation inputs.

The term “response history information” refers to data indicating past interactions between the server and the user, including user requests, prompt sentences, generated response sentences, and associated metadata.

The term “learning data” refers to data used to adjust or train processing logic or models, the data including evaluation information, response history information, and associated contextual information.

The term “processing of determining the intent information” refers to processing that infers intent information from user request content, character information, and/or image information, including classification or prediction procedures.

The term “processing of selecting the function” refers to processing that selects one or more functions, such as the schedule management function or the meal proposal function, based on the determined intent information and target information.

In one embodiment, a server, a terminal, and a user cooperate to realize the claimed system. The server includes at least one hardware processor, a main memory, a nonvolatile storage unit, and a network interface. The terminal includes a hardware processor, a memory, an audio input unit such as a microphone, an audio output unit such as a speaker, and a display unit. The user operates the terminal to provide requests and feedback.

The terminal executes an operating system, such as a mobile operating system or a desktop operating system, and executes an application program implementing a client for the present system. The terminal uses an audio acquisition library, such as an audio recording framework provided by the operating system (for example, an audio recording API on a mobile platform), to acquire user voice information as digital audio data. The terminal also uses a graphical user interface library, such as a user interface framework, to display character information and receive user input by touch or keyboard.

The server executes a server operating system and one or more application programs implementing server-side logic. The server may use a web application framework, such as a generic HTTP server framework, to receive requests from the terminal over a packet-switched network via the network interface. The server stores program instructions and intermediate data in the main memory and executes the instructions on the hardware processor.

The server uses a speech recognition engine to convert user voice information into character information. In one embodiment, the server calls a cloud-based speech recognition service, such as a generic speech-to-text service, through a network API. The server transmits encoded audio frames, for example linear PCM data encoded into a compressed format such as Opus, to the speech recognition service and receives text output as a sequence of characters encoded in a character set such as UTF-8. In another embodiment, the server executes a local neural speech recognition model, implemented as a deep neural network having multiple convolutional and recurrent layers, where acoustic features, such as mel-frequency cepstral coefficients, are extracted by the processor using a digital signal processing library, and the acoustic model and language model jointly infer the most probable character sequence.

The server applies character string processing to the character information. The server executes a normalization module that converts full-width characters to half-width characters, unifies the case of alphabetic characters, standardizes punctuation, and removes redundant whitespace. The server executes an error correction module that identifies likely recognition errors and grammatical errors. In one embodiment, the server uses a generative AI model fine-tuned for text correction. The generative AI model may be implemented as a transformer-based neural network having multiple self-attention layers, feedforward layers, and layer normalization units. The server constructs an internal prompt sentence such as:
“Correct minor recognition and grammar errors in the following sentence without changing the intended meaning:
[recognized sentence]”
and sends this prompt sentence to the generative AI model. The generative AI model outputs a corrected sentence that the server stores as normalized character information.

The server analyzes the normalized character information and optionally image information to determine intent information and target information. The server executes an intent classification module implemented by a neural network model, such as a bidirectional transformer encoder. The server tokenizes the character information into subword units using a vocabulary and mapping table stored in the storage unit. The server feeds the token IDs into the intent classification model to obtain a probability distribution over intent classes, including at least a schedule management class, a movement plan presentation class, a meal proposal class, a character correction class, and an image analysis class. The server selects the intent class having the highest probability exceeding a threshold, and stores the selected class as intent information.

The server also executes an entity extraction module to produce target information. The entity extraction module may be implemented as a sequence labeling model, such as a transformer-based model with a conditional random field output layer. The entity extraction module identifies date expressions, location expressions, time periods, food ingredients, and other entities. The server converts the extracted entities into normalized representations, such as a date range in a standard time zone or a list of canonical ingredient identifiers.

The server selects a function based on the intent information and target information. For example, when the intent information indicates schedule management, the server selects a schedule management function; when the intent information indicates movement planning, the server selects a movement plan presentation function. In one embodiment, the server also consults a generative AI model to confirm or refine the function selection. The server constructs a prompt sentence such as:
“Classify the following user request into one of these categories: SCHEDULE, TRAVEL, FOOD, TEXT, or IMAGE. Answer with a single word.
Request: [normalized user text]”
and sends this prompt to the generative AI model. The generative AI model outputs a single-word label. The server compares this label with the label determined by the intent classification module and applies a rule-based arbitration mechanism. For example, the server may rely on the classifier when its confidence is high and use the generative AI model output when the classifier confidence is low. This hybrid procedure reduces misclassification and improves routing accuracy, which in turn reduces unnecessary external service calls and lowers overall latency.

The server generates inquiry data adapted to the selected function and transmits the inquiry data to an external information processing unit or an internal information processing unit. For schedule management, the server generates a query object containing fields such as a user identifier, a start date-time, and an end date-time, and transmits the query to a calendar management service over a network interface by using a standardized web API. The external calendar management service responds with schedule information in a structured format, such as a list of event records, each containing a timestamp, a duration, a location, and a description. For movement plan presentation, the server generates parameters defining an origin location, a destination constraint, allowable transport modes, time windows, and budget constraints, and transmits them to a route search or travel planning service. For meal proposal, the server constructs ingredient lists and nutritional constraints and sends them to a recipe retrieval service. For character correction, the server transmits the original user text to a text editing module. For image analysis, the server may send image information to a vision analysis module that executes a convolutional neural network or a vision transformer network to identify objects, text regions, or scene categories.

The server receives processing result data from the external or internal information processing unit. The server then aggregates the processing result data into structured data of a predetermined format. For example, the server converts schedule event records into a canonical structure with normalized time zones and standard field names, converts travel options into a ranked list sorted by a score that combines price and travel time, and converts recipes into a structure containing a title, total calories, ingredient list, and cooking steps. The server stores the structured data in a structured data store, such as an in-memory key-value store or a relational database table, together with an identifier associated with the user request.

The server generates a prompt sentence for a generative AI model based on the user request content and the structured data. The server composes a prompt sentence that includes not only the raw user text but also a summarized representation of the structured data and explicit instructions regarding style and length. For example, in the case of a schedule query, the server creates a prompt sentence of the form:
“You are a personal assistant.
User request: ‘Tell me my schedule for tomorrow.’
Calendar events (sorted by time):
1. 2026-01-31 10:00-11:00, Meeting with team, Office
2. 2026-01-31 13:00-14:00, Lunch with client, Restaurant
3. 2026-01-31 15:30-16:30, Project review, Meeting room
Using natural English, summarize the user's schedule for tomorrow in two or three sentences.”

In a travel planning scenario, the server constructs a prompt sentence such as:
“User request: ‘Recommend a travel destination for the next long weekend.’
User profile: prefers warm climate, medium budget, departure city is the user's home city.
Candidate destinations:
1. Destination A, total cost: medium, flight time: short.
2. Destination B, total cost: low, flight time: medium.
3. Destination C, total cost: medium, flight time: long.
Choose two destinations and explain briefly why they are suitable for the user.”

In a meal proposal scenario, the server uses a prompt sentence such as:
“User request: ‘Suggest a dinner menu that is low in calories and uses chicken.’
Candidate recipes with calories and preparation times:
1. Grilled chicken salad, 450 kcal, 20 minutes.
2. Chicken vegetable soup, 380 kcal, 25 minutes.
3. Stir-fried chicken and vegetables, 500 kcal, 15 minutes.
Propose one menu and describe how to cook it in under 30 minutes, using simple language.”

The server sends the generated prompt sentence to the generative AI model. The generative AI model may be hosted on the server or on a separate processing unit. In one embodiment, the generative AI model is implemented as a transformer-based neural network comprising an embedding layer, multiple self-attention layers, multiple feedforward layers, layer normalization layers, and an output layer coupled to a vocabulary. The generative AI model processes the prompt sentence token-by-token and generates a sequence of output tokens representing the response sentence. The server decodes the output tokens into characters and concatenates them into a response sentence string.

The server optionally monitors the length, expression, and content of the response sentence. The server may apply a content filter, such as a rule-based or classifier-based module, to detect responses that exceed a maximum token length, include disallowed expressions, or omit mandatory fields. When the response sentence fails such checks, the server generates an additional prompt sentence that includes constraints such as “Make the answer shorter” or “Include all event times explicitly,” and re-invokes the generative AI model. This post-processing reduces output variability and ensures that the generative AI model remains aligned with the structured data and explicit output requirements, thereby improving reliability and reducing the need for manual correction.

The server generates output information for the terminal based on the final response sentence. The server places the response sentence and optional metadata into an output data structure and transmits it to the terminal. The terminal receives the output information and displays the response sentence on the display unit using a text rendering library. The terminal also uses a text-to-speech engine provided by the operating system or a speech synthesis service to generate synthesized speech from the response sentence, and outputs the synthesized speech through the speaker. In this manner, the user receives the system's response in visual and/or audio form.

The user can provide evaluation information and response history information. The terminal presents interface elements such as rating buttons, thumbs-up and thumbs-down icons, or free-text comment fields. The user selects a rating or enters a comment describing the usefulness, accuracy, or style of the response sentence. The terminal packages the evaluation information and the corresponding request identifier into a feedback message and sends it to the server.

The server receives the evaluation information and response history information and stores them as learning data in a storage unit. The server associates the learning data with elements of the processing pipeline, including the intent classification results, the selected function, the structured data, the prompt sentence, and the response sentence. The server periodically or incrementally updates parameters of the intent classification model and the function selection rules using supervised learning. For example, the server minimizes a loss function such as cross-entropy between predicted intent labels and corrected labels derived from user feedback. The server adjusts hyperparameters, such as thresholds used to select functions, based on aggregated feedback statistics. The server also adjusts prompt generation templates by changing default phrasing, length constraints, or data selection policies when persistent patterns of negative feedback are observed.

In one embodiment, the server uses a training procedure for the neural models that includes selecting mini-batches of training examples from the learning data, computing forward passes through the models on the hardware processor or an attached hardware accelerator such as a graphics processor, evaluating a loss function such as a negative log-likelihood function or a cross-entropy function, and updating model weights by gradient-based optimization, for example stochastic gradient descent with adaptive learning rates. The server may augment training data by applying paraphrasing to user requests or small perturbations to structured data, in order to improve generalization and robustness. The server thus incrementally improves internal models on the basis of real-world interactions without requiring manual rule maintenance.

The described architecture and data flow produce technical effects that go beyond a mere automation of human tasks. The server normalizes and corrects user input at an early stage, which reduces noise for subsequent modules. This reduction enables intent classification and entity extraction to operate on more consistent inputs, thereby increasing accuracy. Higher accuracy in turn reduces misrouted calls to external services, minimizing unnecessary network communication and conserving computational resources. The structured aggregation of processing result data and its systematic integration into prompt sentences reduces the number of tokens required for each generative model invocation and prevents the generative AI model from inferring missing information, which decreases latency and model compute load.

The hybrid selection of functions using both a classifier and a generative AI model improves robustness under ambiguous or noisy inputs, yielding fewer erroneous paths and reducing the need for repeated user clarification. The feedback-driven updating of intent determination, function selection, and prompt generation logic allows the system to adapt to user behavior patterns and data distributions over time, improving accuracy and throughput without manual reconfiguration. Because the system controls the generative AI model via carefully structured prompt sentences derived from machine-readable structured data, the server can enforce consistent formatting and content coverage, which stabilizes downstream processes such as automated event creation or travel booking.

The terminal and server together thus form a specific technical configuration that processes heterogeneous multimodal data, performs non-trivial normalization and model-based decision making, and tightly couples structured data processing with generative AI output control. This configuration reduces communication overhead by avoiding redundant or overly broad queries to external services, enhances computational efficiency by narrowing model input to relevant structured context, and decreases user-perceived latency by minimizing reprocessing triggered by misclassifications or inadequate responses. As a result, the system implements an improvement in the underlying computer technology used for multimodal interactive information processing, rather than simply replicating manual human operations.

In alternative embodiments, the server may employ different neural network architectures for the intent classification module, such as a recurrent neural network with long short-term memory units or a convolutional neural network applied to character-level inputs. The generative AI model may be replaced with a smaller or domain-specific generative model to reduce resource usage. The structured data format may be realized as relational tables or as tree structures, and the aggregation logic may rank or filter results using different scoring functions. The speech recognition engine may be a locally hosted model or a network-based service. The image analysis function may use a vision transformer or a convolutional backbone. These variations do not depart from the spirit of the invention, as the essential features remain: normalization and correction of user inputs, determination of intent and selection of at least one function, aggregation of processing result data into structured data, generation of a prompt sentence for a generative AI model, and adaptive updating of internal processing based on learning data.

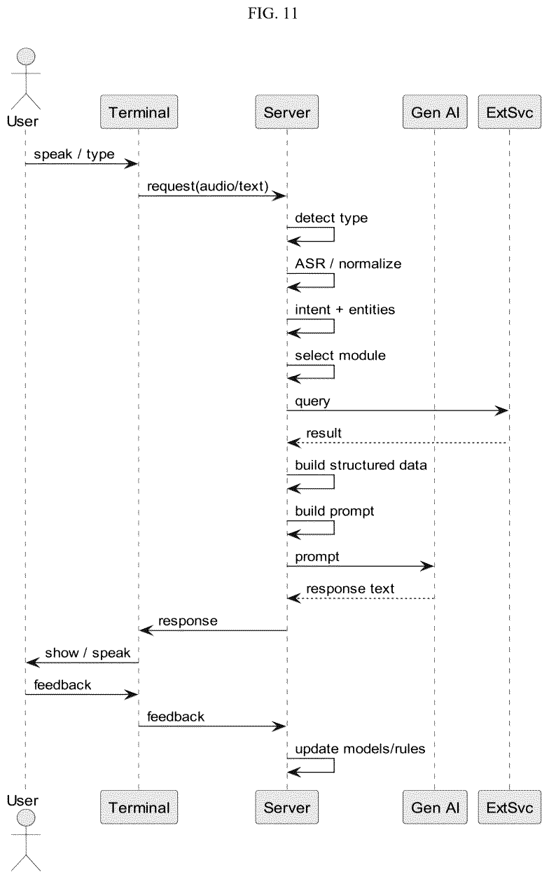

The following describes the processing flow using FIG. 11.

### Step 1:

The user provides an initial request.

The user speaks into the terminal microphone or types text into a user interface.

Input: A spoken utterance or a typed text string.

Output: Raw audio data captured by the microphone or raw text data captured by the user interface.

### Step 2:

The terminal captures the user input and sends it to the server.

The terminal samples the audio signal from the microphone, digitizes it into audio frames (for example, 16-bit PCM at a fixed sampling rate), optionally encodes the frames using an audio codec, and packages the audio or text in a network message. The terminal attaches metadata such as user ID, language setting, and device identifier, and transmits the message to the server via a secure communication protocol.

Input: Raw audio data or raw text data from the user, plus device metadata.

Output: A structured request message delivered to the server containing audio data or text data and associated metadata.

### Step 3:

The server receives the request and discriminates the input type.

The server parses the received message, inspects header fields or content-type indicators, and determines whether the payload includes audio data, text data, or both. The server stores a record of the request, including timestamps and user identifiers, in a request log.

Input: The structured request message from the terminal.

Output: A normalized internal request object containing an input type indicator, the raw payload (audio or text), and associated metadata.

### Step 4:

The server converts voice information into character information when audio is present.

The server detects that the internal request object contains audio data, extracts the audio frames, and forwards them to a speech recognition component. The server uses a speech recognition engine (local or network-based) to compute acoustic features, perform pattern matching with an acoustic model and language model, and output a best-matching transcription. The server then decodes the recognition result into a character string.

Input: Raw audio data in the internal request object.

Output: A recognized text string representing the user's speech, stored as character information.

### Step 5:

The server normalizes and corrects the character information.

The server applies character string processing to the recognized or directly received text. The server converts character types, unifies letter case, standardizes punctuation, and removes redundant control characters. The server optionally invokes a correction module, which may use a generative AI model with a prompt sentence such as “Correct minor recognition and grammar errors in the following sentence without changing the intended meaning: [sentence]”. The server compares the corrected text with the original text and adopts the corrected version when improvements are detected.

Input: Raw or recognized character information.

Output: Normalized and corrected character information suitable for downstream analysis.

### Step 6:

The server performs intent analysis and entity extraction.

The server feeds the normalized text into an intent classification model and an entity extraction model. The server tokenizes the text into tokens, converts tokens into numerical representations, and executes the models to obtain a probability distribution over possible intents (for example, SCHEDULE, TRAVEL, FOOD, TEXT, IMAGE) and a set of labeled entities (for example, dates, locations, ingredients). The server selects the most probable intent and converts the entities into canonical formats.

Input: Normalized and corrected character information.

Output: Intent information indicating the user's purpose, and target information indicating relevant entities and parameters.

### Step 7:

The server determines and confirms the functional module to be used.

The server maps the intent information to at least one functional module, such as a schedule management module, a movement plan presentation module, or a meal proposal module. The server may construct a short prompt sentence for a generative AI model, such as “Classify the following user request into one of these categories: SCHEDULE, TRAVEL, FOOD, TEXT, or IMAGE. Answer with a single word. Request: [normalized text]”, and send it to the generative AI model to obtain a category label. The server compares the category label with the classifier output and uses rules or thresholds to finalize the module selection.

Input: Intent information and target information derived from the text.

Output: A selected function identifier indicating at least one functional module to be executed.

### Step 8:

The server prepares inquiry data for external or internal processing units.

The server constructs a data structure that encodes all parameters needed by the selected module. For schedule management, the server includes user identifiers and a time range; for movement planning, the server includes origin, time constraints, and budget; for meal proposal, the server includes ingredient lists and dietary constraints. The server transforms natural language entities into machine-readable fields and stores them in a well-defined query object.

Input: The selected function identifier, intent information, and target information.

Output: Inquiry data specifying module type, parameters, and constraints, ready to be transmitted to processing units.

### Step 9:

The server executes the selected functional module and obtains processing results.

The server routes the inquiry data to the corresponding module. When the module relies on an external service, the server invokes an external interface, formats the inquiry data as an API request, and sends it over the network. When the module runs internally, the server calls the relevant software component or accesses a database. The module computes its result (for example, retrieving calendar events, ranking travel routes, or selecting recipes) and returns structured output.

Input: Inquiry data associated with the selected function.

Output: Processing result data, such as a list of events, travel options, meal candidates, corrected text, or image analysis results.

### Step 10:

The server aggregates and structures the processing result data.

The server merges the raw outputs from one or more modules into a unified structured format. The server filters out irrelevant entries, ranks items based on scoring rules (for example, by time order or combined cost-time score), and normalizes fields such as timestamps, units, and labels. The server stores the aggregated information in a structured data representation with clearly defined fields.

Input: Processing result data produced by the functional module(s).

Output: Structured data in a predetermined format summarizing the module results.

### Step 11:

The server constructs a prompt sentence for the generative AI model.

The server combines the user request content and the structured data into a text instruction.

The server adds constraints about style, length, and language. For example, the server may generate a prompt sentence such as:
“You are a personal assistant.
User request: ‘Tell me my schedule for tomorrow.’
Calendar events (sorted by time):
1. [event 1]
2. [event 2]
Using natural English, summarize the user's schedule for tomorrow in two or three sentences.”

The server formats this prompt sentence as character information to be input to the generative AI model.

Input: User request content and structured data produced from the module results.

Output: A prompt sentence that encapsulates instructions and context for the generative AI model.

### Step 12:

The server invokes the generative AI model and obtains a response sentence.

The server transmits the prompt sentence to the generative AI model interface and waits for the model to generate a sequence of tokens. The server decodes the tokens into text form, creating a coherent natural-language response that reflects the structured data and constraints given in the prompt.

Input: The constructed prompt sentence.

Output: A response sentence expressed in natural language.

### Step 13:

The server validates and, if necessary, regenerates the response sentence.

The server inspects the response sentence for length limits, mandatory information, and prohibited content. The server may use heuristic rules or a classifier to check whether all key elements from the structured data have been described. If deficiencies are detected, the server constructs an additional prompt sentence including guidance such as “Make the answer shorter” or “Include the specific times of all events,” and calls the generative AI model again.

Input: The initial response sentence and the structured data.

Output: A final vetted response sentence that satisfies formatting and content requirements.

### Step 14:

The server generates output information and transmits it to the terminal.

The server packages the response sentence into an output message, optionally attaching metadata such as identifiers of events or options referenced in the text. The server formats the message as a structured response and sends it to the terminal over the network.

Input: The final response sentence and optional metadata.

Output: A response message delivered to the terminal for presentation to the user.

### Step 15:

The terminal presents the response to the user.

The terminal parses the received message, extracts the response sentence, and displays it on the display unit using a text layout mechanism. The terminal may also invoke a text-to-speech engine to synthesize spoken output from the response sentence and play it through the speaker.

Input: The response message received from the server.

Output: Visual text and/or audible speech presented to the user.

### Step 16:

The user provides feedback on the presented response.

The user interacts with graphical controls on the terminal to indicate satisfaction or dissatisfaction, for example by selecting a rating, pressing an approval or disapproval button, or entering a comment.

Input: The response presented by the terminal and the user's subjective evaluation.

Output: Feedback actions or comments entered into the terminal interface.

### Step 17:

The terminal sends the feedback information to the server.

The terminal converts the user's feedback actions into structured feedback data, associates the feedback with the corresponding request or response identifier, and transmits the feedback to the server as a feedback message.

Input: User feedback actions and comments.

Output: A feedback message containing evaluation information and references to the related interaction.

### Step 18:

The server stores and utilizes the feedback as learning data.

The server receives the feedback message, logs the evaluation information and response history, and stores them as learning data in a storage unit. The server correlates the feedback with particular intent determinations, function selections, structured data constructions, and prompt sentences. The server later uses this learning data to adjust model parameters, thresholds, and prompt templates, thereby improving accuracy and efficiency of future processing.

Input: Feedback message containing evaluation information and response history identifiers.

Output: Updated learning data and, over time, refined internal models and rules that influence subsequent processing.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-assisted recommendation and assistance systems suffer from several technical limitations in how they process heterogeneous user inputs and produce personalized outputs. In many existing architectures, audio input, image input, and historical user data are handled in separate, loosely coupled subsystems, which leads to redundant processing, inconsistent internal representations, and increased latency. For example, audio is often converted to text in one subsystem, images are analyzed in another subsystem, and recommendation logic is executed in a separate application layer that is not tightly integrated with model-based personalization. As a result, the overall system must perform multiple passes of parsing and transformation, causing inefficient use of computational resources and delays in generating outputs on user devices.

Furthermore, known systems typically treat recommendation engines, generative artificial intelligence models, and schedule management functions as independent components. In such configurations, a recommendation engine may compute scores based on user history, while a generative artificial intelligence model separately produces natural language responses without direct access to the internal scoring signals. This separation prevents the generative artificial intelligence model from fully leveraging structured evaluation values and feature-level user preference data, which limits the precision and relevance of generated explanations and proposals. It also requires additional ad hoc glue logic and manual prompt crafting, which introduces complexity and potential errors.

Another technical challenge arises from the need to continuously update personalization models based on user interactions. In traditional systems, user feedback, such as final selections of recommended items, is either not systematically recorded or is used only in offline batch processing. This results in static or slowly adapting models that do not promptly reflect evolving user preferences. Moreover, because the recording of user selections is not tightly integrated with the feature extraction and model training pipeline, designers must implement separate data collection and retraining workflows, increasing system complexity and maintenance cost.

Additionally, many existing reminder and schedule management systems process natural language commands and calendar data using rule-based logic. These systems typically rely on fixed templates for notification messages and do not make effective use of generative artificial intelligence models. Consequently, they cannot flexibly tailor notification texts to the user's context or integrate schedule information into the same multi-modal, model-driven workflow that handles recommendations. This fragmented processing pipeline leads to inconsistent user experience and inefficient reuse of computational components.

Accordingly, there is a need for an improved computer-implemented system that unifies audio processing, image analysis, user history acquisition, machine learning-based scoring, and generative artificial intelligence-based text generation within a single integrated processing pipeline executed by a processor. Such a system should generate prompt sentences for a generative artificial intelligence model directly from structured internal data, including user preference information and candidate item evaluation values, and should record user final selections in a form that can be immediately reused to adaptively update the underlying machine learning model. In addition, an improved system should apply the same integrated architecture to schedule management and reminder generation, thereby enhancing computational efficiency, consistency of internal representations, and responsiveness of personalization across different functions.

The specific processing by the specific processing unit 290 of the data processing device 12 in Application Example 1 is realized by the following means.

The present invention provides a server comprising a processor configured to acquire audio information and convert the audio information into character information by natural language processing, acquire image information or video information and convert the image information or the video information into feature information and recognized character information by image analysis, acquire past selection history information and behavior history information from a storage unit based on user identification information and generate user preference information by performing statistical processing and feature extraction processing on the acquired history information, calculate, based on the user preference information, the character information, and the feature information, an evaluation value for each candidate item by using a machine learning model and select at least one candidate item based on the evaluation value, generate, based on the user preference information, the at least one candidate item, the evaluation value, the character information, and the feature information, a prompt sentence to be input to a generative artificial intelligence model and transmit the prompt sentence to the generative artificial intelligence model, generate, based on response information acquired from the generative artificial intelligence model, explanation information or proposal information regarding the at least one candidate item and transmit the explanation information or the proposal information as output information to a terminal device, record, in the storage unit, final selection information of a user transmitted from the terminal device and update the past selection history information based on the final selection information, and, in some embodiments, extract schedule information from the character information, register the schedule information in a schedule management storage area, and generate reminder information by transmitting to the generative artificial intelligence model a prompt sentence including the schedule information to obtain a notification text. This enables an integrated and technically improved processing pipeline in which heterogeneous user inputs are converted into unified internal representations, candidate items are scored and selected by a machine learning model, prompt sentences are automatically constructed from structured evaluation values and user preference information for a generative artificial intelligence model, outputs are generated as contextually consistent explanations and proposals, user selections are immediately fed back into the storage unit for adaptive model updating, and schedule-related reminders are produced within the same model-driven architecture, thereby enhancing computational efficiency, personalization accuracy, and responsiveness of the computer system.

The term “audio information” refers to data representing sound captured from a user, including analog or digital signals obtained through a microphone or other acoustic sensor and suitable for processing by a computing device.

The term “character information” refers to textual data obtained by converting audio information or other inputs into a sequence of characters, symbols, or tokens that can be processed by natural language processing.

The term “natural language processing” refers to computational techniques and algorithms for analyzing, transforming, or generating human language, including processes such as speech recognition, tokenization, part-of-speech tagging, parsing, and semantic interpretation.

The term “image information” refers to data representing a still visual scene, including bitmap or vector image data acquired from an imaging sensor or storage, and suitable for processing by image analysis.

The term “video information” refers to data representing a time sequence of visual frames, including encoded or unencoded video streams or collections of images suitable for temporal and spatial analysis by a computing device.

The term “feature information” refers to structured data derived from image information or video information, representing characteristics such as detected objects, shapes, colors, labels, or other attributes extracted by image analysis.

The term “recognized character information” refers to textual data obtained from image information or video information by optical character recognition or similar techniques that detect and convert visible characters into machine-readable text.

The term “image analysis” refers to computational processing applied to image information or video information to detect, classify, or segment visual elements and to generate feature information and recognized character information.

The term “user identification information” refers to data that uniquely or pseudo-uniquely identifies a user or user account, such as an identifier, token, or credential used to associate processing with a particular user.

The term “storage unit” refers to one or more physical or virtual storage resources, such as memory devices or database systems, configured to store and retrieve data including history information, preference information, and schedule information.

The term “past selection history information” refers to stored records of items or options previously selected or confirmed by a user, including identifiers, timestamps, categories, and contextual attributes associated with each selection.

The term “behavior history information” refers to stored records of user activities other than explicit selections, including actions, queries, interactions, navigation patterns, or other observed behavior over time.

The term “statistical processing” refers to computational operations that aggregate, summarize, or analyze data using statistical measures, such as counts, frequencies, averages, distributions, or correlations.

The term “feature extraction processing” refers to computational transformation that converts raw or semi-structured data into a set of descriptive attributes or features suitable for input to a machine learning model.

The term “user preference information” refers to data structures representing inferred or explicit preferences of a user, generated from past selection history information and behavior history information, and used to influence subsequent processing and recommendations.

The term “machine learning model” refers to a computational model that has been trained on data to learn parameter values for performing tasks such as classification, regression, ranking, or recommendation, and that can output evaluation values based on input features.

The term “evaluation value” refers to a numeric or otherwise ordered score output by a machine learning model that represents a relative desirability, relevance, or suitability of a candidate item for a user or context.

The term “candidate item” refers to an option, object, or entity under consideration for recommendation or selection, such as a product, content item, service, schedule entry, or other selectable entity in an application domain.

The term “generative artificial intelligence model” refers to a computational model that generates content, such as text, based on input data or instructions, including models implemented using neural networks that produce natural language responses.

The term “prompt sentence” refers to textual input supplied to a generative artificial intelligence model, including instructions, context, and structured information, that guides the model to generate a desired type of output.

The term “response information” refers to output data produced by a generative artificial intelligence model in response to a prompt sentence, including generated text and optionally associated structured metadata.

The term “explanation information” refers to generated content that describes reasons, factors, or justifications underlying a recommendation or selection of a candidate item, intended to make system behavior understandable to a user.

The term “proposal information” refers to generated content that suggests one or more actions, items, or plans to a user, based on user preference information, evaluation values, and other context.

The term “output information” refers to data prepared for transmission from the server to a terminal device, including explanation information, proposal information, and any associated identifiers or parameters needed for presentation.

The term “terminal device” refers to an end-user computing device, such as a smartphone, tablet, wearable device, or other client device, configured to communicate with the server, present outputs, and capture user inputs.

The term “final selection information” refers to data indicating a user's confirmed choice among one or more candidate items, including identifiers of selected items and, optionally, contextual information about the selection.

The term “schedule information” refers to data representing planned events or activities of a user, including times, dates, titles, locations, and other attributes suitable for calendar or reminder management.

The term “schedule management storage area” refers to a portion of the storage unit allocated to store schedule information, such as a data structure or database area dedicated to calendar-related records.

The term “notification text” refers to generated textual content intended to notify a user about schedule information, reminders, or other alerts, and suitable for display or speech output at a terminal device.

The term “reminder information” refers to data specifying a notice or alert to be provided to a user at or around a certain time or condition, including notification text and associated trigger parameters.

In one embodiment, a server cooperates with one or more terminals operated by a user to implement the claimed system. The server comprises at least one processor, a non-transitory storage unit, a network interface, and access to external computing services. The terminal comprises an input/output interface including a microphone, a display, one or more loudspeakers, and, in some cases, a camera and location sensor. The user operates the terminal to provide audio input, image input, and selection input, and to receive recommendation outputs, explanation outputs, and reminder outputs.

The server executes an application program that is stored in the storage unit. The server uses a general-purpose operating system, a web application framework, and client libraries for a speech recognition service, an image analysis service, and a database service. In one implementation, the server uses a web framework such as a script-based web server framework, a speech recognition API such as a cloud-based speech-to-text service, an image analysis API such as a cloud-based vision service, a machine learning framework such as a tensor-based neural network library, and a cloud database service such as a document-oriented database. The server thereby performs data transformations on audio information, image information, and text information, and performs computations in a machine learning model and a generative AI model.

The terminal runs a client application on a mobile operating system or a wearable operating system. The terminal uses an audio API to control the microphone, a camera API to capture image information, and a GUI framework to render visual outputs. The terminal sends audio information, image information, and character information to the server over a secure communication protocol, and receives output information from the server. The user interacts by speaking into the microphone, by capturing photos or videos with the camera, and by selecting candidate items displayed on the display.

The server stores past selection history information, behavior history information, user preference information, schedule information, and model parameters in the storage unit. In one form, the server organizes the past selection history information as a set of records, each record containing a user identifier, a candidate item identifier, a timestamp, a category code, a context code, and an outcome flag. The server stores behavior history information as records representing user queries, clicks, dwell time, and navigation patterns. The server stores schedule information as records containing a user identifier, a date and time, an event title, and optional location and description fields. The server stores user preference information as a vector of preference scores per category, and as statistics such as frequency counts and recency-weighted scores.

The server converts audio information into character information by executing a speech recognition client module. The server sends compressed audio frames and configuration parameters, including sampling rate, language code, and encoding type, to a remote speech recognition service. The remote service returns a transcription result with a sequence of tokens and confidence values. The server selects the best hypothesis and uses it as the character information representing the user's spoken input. By offloading low-level acoustic modeling to the dedicated service and by integrating the returned tokens into the server's unified representation, the server reduces on-device computation on the terminal and centralizes language-specific processing on the server.

The server converts image information or video information into feature information and recognized character information by executing an image analysis client module. The server submits image data to a remote image analysis service with a request to perform object detection, label assignment, and optical character recognition. The server receives, from the remote service, a set of labels with confidence scores, bounding box coordinates for detected objects, and strings of recognized characters. The server maps labels to standardized category codes and stores them as feature information. The server stores recognized character information as text strings associated with the image record in the storage unit. The server uses these representations to link visual content, such as menu images or travel brochures, with the user's preference profile and candidate items.

The server generates user preference information by performing statistical processing and feature extraction processing on the past selection history information and the behavior history information. The server computes, for each category such as cuisine type, transport mode, or time-of-day preference, a set of statistics including normalized frequency, average rating, and temporal decay-adjusted weights. The server applies feature extraction processing, such as one-hot encoding of categorical variables, embedding lookup for item identifiers, and scaling of numeric variables. The server concatenates these features into a fixed-length feature vector per user. The server then stores this feature vector as user preference information in the storage unit. Because the server maintains this vector in a standardized numeric format, the server can pass it directly to the machine learning model without recomputing raw statistics for every request, improving computation efficiency and latency.

The server implements the machine learning model as a neural network-based ranking model. In one embodiment, the server defines a feedforward neural network comprising an input layer, multiple fully connected hidden layers with non-linear activation functions, such as rectified linear unit functions, and an output layer that produces evaluation values for candidate items. The input of the neural network combines user preference information with candidate item features. Candidate item features include categorical encodings of item type, location region, price band, and historical popularity, and numeric encodings of contextual features such as time-of-day, day-of-week, and device type. The server normalizes all numeric features to a predetermined range and stores model weights and biases in the storage unit as arrays of floating-point parameters.

The server trains the machine learning model by supervised learning. The server constructs training examples in which an input feature vector corresponds to a set of candidate items and a target label indicates which items were actually selected by the user. The server defines a loss function, such as a pairwise ranking loss or cross-entropy loss, measuring the discrepancy between predicted evaluation values and observed selections. The server performs gradient-based optimization, such as stochastic gradient descent or an adaptive gradient method, to update model parameters. In particular, the server computes gradients of the loss function with respect to each weight and bias using backpropagation, multiplies gradients by a learning rate, and subtracts the result from the current parameters. The server periodically retrains or fine-tunes the model using newly accumulated final selection information stored in the storage unit, so that the model reflects evolving user preferences and improves recommendation accuracy.

The server calculates, for each candidate item, an evaluation value by providing the combined feature vector to the neural network and computing forward propagation through each layer. The server applies activation functions and matrix multiplications to compute the network output. The server then normalizes or transforms the network output into an evaluation value, for example by applying a softmax function across items to yield a probability distribution or by using a sigmoid function for independent relevance scores. The server uses the evaluation values to rank candidate items and selects at least one candidate item as a recommendation or as an input to subsequent processing.

The server generates a prompt sentence for a generative AI model by combining user preference information, candidate item information, evaluation values, character information, and feature information into a structured narrative template. The server does not simply forward the user's input text. Instead, the server constructs the prompt sentence by embedding internal, machine-readable signals, such as the names and attributes of top-ranked candidate items and their evaluation values, into natural language instructions that guide the generative AI model. In one example, the server generates a prompt sentence of the form: “You are a personalized recommendation assistant. The user asked: ‘What should I eat today?’ The user's past order history (summarized): prefers Italian food, often orders pizza on weekdays, medium price range, location: near downtown. Candidate options with scores: Restaurant A (Italian, pizza, score 0.91), Restaurant B (Italian, pasta, score 0.87), Restaurant C (Japanese, sushi, score 0.40). Please recommend one restaurant and one dish, explain briefly why they match the user's preferences, and respond in friendly English within three sentences.”

In another example relating to travel planning, the server generates a prompt sentence of the form:

“You are a travel planning assistant. The user's past trips and preferences indicate a preference for trains over airplanes, morning departures, and standard-class seats. The user requested: ‘I want to go to Osaka next weekend by train under 20,000 yen.’ The following train options and their scores are available: Option 1 (express train, departure 8:00, price 18,000, score 0.88), Option 2 (express train, departure 11:00, price 19,500, score 0.83), Option 3 (local train, departure 7:30, price 15,000, score 0.65). Please select one optimal plan within the budget and explain the reasoning in polite English.”

In a text correction scenario, the server generates a prompt sentence of the form:

“Please correct grammar, spelling, and style of the following English text. Return only the corrected version without additional comments. Text: ‘I has finish the report yesterday but I not send it yet.’”

The server transmits the generated prompt sentence to a generative AI model hosted on a remote inference service or, in some variations, running on the server itself. The generative AI model may be a transformer-based neural network with multiple self-attention layers, feedforward layers, and positional encoding, pre-trained on large-scale text data and optionally fine-tuned for instruction following. The server uses a client library to call an API that accepts the prompt sentence and returns response information. The server sets parameters such as temperature, maximum token count, and stop conditions to control the style and length of the generated text.

The server generates explanation information or proposal information from the response information. In many embodiments, the server directly uses the returned natural language text as explanation information and attaches identifiers of the candidate items referenced in the text. In some embodiments, the server parses the response information to extract structured elements, such as the name of the recommended item, the justification, and any constraints.

The server then formats this information as output information and transmits it to the terminal. The terminal presents the explanation information on the display using graphical components and, optionally, uses a text-to-speech engine to output the information as synthesized speech. By integrating the generative AI model with the machine learning model via explicit prompt sentences, the server ensures that the generative AI model operates on a rich, structured representation of the underlying recommendation computation, which improves the coherence and relevance of the generated narrative compared to naive text-only approaches.

The server records final selection information from the terminal in the storage unit. When the user selects one of the recommended items on the terminal, the terminal sends the identifier of the selected item and contextual metadata to the server. The server writes a new record in the past selection history information subsystem, updating counters and time stamps. The server also marks which recommended items were not selected, thereby generating negative examples. This immediate recording establishes a closed loop between recommendation generation and model training, enabling the server to periodically retrain the machine learning model with fresh data and to adjust preference scores more quickly. As a result, the system improves recommendation precision and reduces user-perceived errors over time.

The server also processes schedule information using the same unified architecture. The server extracts schedule information from character information by applying natural language processing and rule-based parsing. For example, when the user says “Schedule a meeting with Tanaka tomorrow at 3 p.m.” through the terminal, the server first obtains the character information from the speech recognition component. The server then uses a combination of pattern matching and named-entity recognition to identify the date, time, and title (“meeting with Tanaka”). The server normalizes “tomorrow” into a specific date based on the server's current time, assigns a start time of 15:00, and stores the event as schedule information in the schedule management storage area.

The server generates reminder information by constructing a prompt sentence that includes the schedule information and sends it to the generative AI model. For example, the server can use a prompt sentence such as:

“You are a notification assistant. Create a concise reminder message for the following event: ‘Meeting with Tanaka on 2026 Feb. 1 at 15:00’. The message should be polite and suitable for display on a smartphone notification.”

The generative AI model returns a notification text such as “Reminder: You have a meeting with Tanaka today at 3:00 PM.” The server combines this notification text with trigger parameters, such as the scheduled time minus a predefined offset, and generates reminder information. The server sends the reminder information to the terminal at the appropriate time, and the terminal displays a notification banner and, optionally, plays an alert tone. Because the same architecture processes both recommendation scenarios and schedule scenarios, the server reuses the generative AI model integration and data structures, reducing complexity and improving consistency of user experience.

The described architecture provides several technical improvements over conventional systems. By centralizing audio, image, and text processing pipelines on the server and by representing user preferences and candidate items as unified feature vectors, the server reduces redundant transformations and accelerates response generation. The server uses optimized neural network inference libraries and batched processing to handle multiple requests in parallel, thereby improving throughput and scalability. The explicit separation of machine learning-based scoring (in the neural network model) from natural language generation (in the generative AI model), combined with the use of prompt sentences that encode internal evaluation values, allows the system to exploit structured signals that are not visible in purely text-based systems, leading to higher-quality, more accurate recommendations and explanations.

Moreover, the server does not simply automate a human operator's rule-based decision-making. The server employs a non-conventional combination of dual-model processing: a discriminative model (the machine learning model) that computes evaluation values based on learned feature weights, and a generative model that synthesizes natural language from those internal scores. The server performs continuous online adaptation by recording final selection information and using it to update preference vectors and retrain the machine learning model. This feedback loop operates with granular, high-dimensional feature vectors and large parameter sets that are impractical for manual processing, thereby improving the underlying computer's predictive capability as a technical system, not merely implementing an abstract business rule.

The neural network architecture and training procedure are specifically tailored to handle heterogeneous inputs. The input layer receives concatenated vectors combining user preference features, context features, and candidate item features. Hidden layers use non-linear activations to approximate complex, non-linear relationships between these inputs. The output layer produces scalar scores per candidate item, which the server interprets as evaluation values. The server trains this network using mini-batch optimization, shuffling examples and applying gradient updates in batches to stabilize learning. The server may use regularization techniques, such as dropout or L2 weight decay, to prevent overfitting and to enhance generalization. These technical design choices improve the stability and accuracy of inference on resource-constrained hardware.

The system architecture also reduces communication load. Because the server maintains long-term histories and preference profiles, the terminal does not need to transmit full histories with every request. The terminal only sends raw user inputs (audio, images, text, and selections), and the server derives all necessary context from records in the storage unit. This reduces the size of network payloads and decreases latency. Additionally, the server can cache intermediate representations, such as user preference vectors and candidate item embeddings, to serve multiple related requests more quickly. These optimizations yield a measurable reduction in average response time and network bandwidth consumption. Various alternative embodiments are possible within the scope of the claims. In some embodiments, the server executes the generative AI model locally, using a compact transformer model optimized for the server hardware. In other embodiments, the terminal executes a lightweight variant of the machine learning model for offline or low-latency recommendations, while the server executes full-scale models when connectivity is available.

In yet another embodiment, the system uses an alternative model architecture, such as a gradient-boosted decision tree ensemble, for computing evaluation values, while still employing the same prompt sentence generation and generative AI model integration. In all such cases, the core structure remains: the server computes evaluation values for candidate items using learned parameters, constructs prompt sentences embedding these values and user preference information, obtains natural language response information from a generative AI model, and records final selection information for adaptive updating.

By linking these functional components with concrete data structures, feature transformations, neural network architectures, and training procedures, the present system provides a specific, technical solution implemented in computer hardware and software. The server improves the way computer systems manage multi-modal user inputs, maintain and update complex preference profiles, and generate coherent, personalized natural language outputs. This leads to improved processing speed, recommendation accuracy, and resource utilization compared to conventional, more loosely integrated systems, and thereby constitutes an improvement in computer technology itself.

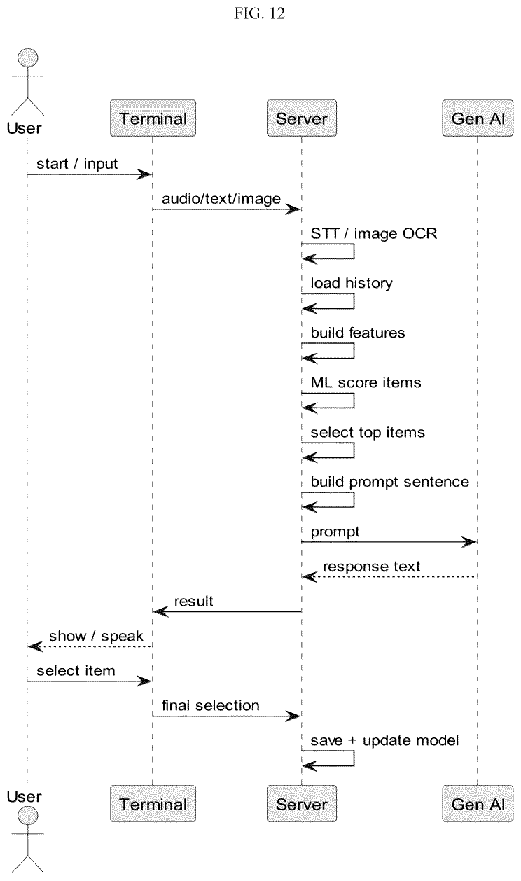

The following describes the processing flow using FIG. 12.

### Step 1:

The user operates the terminal to start an interaction. The user presses a button on a graphical user interface of the terminal and then provides an input, such as speaking into a microphone, typing text into a text field, or capturing an image with a camera. The input of this step is raw user intention expressed as voice, text, or image. The output of this step is device-level input data, such as digital audio samples, character strings, or image pixels, stored in the terminal's memory.

### Step 2:

The terminal acquires the user input using hardware control APIs. The terminal uses an audio API to sample the microphone signal and generate a digital audio stream, uses a keyboard or touch interface to collect typed character strings, or uses a camera API to capture image frames and encode them as image files. The input of this step is the analog voice signal, physical user actions on the screen, or light captured by the camera. The output of this step is structured digital input data, including audio buffers with sampling rate metadata, UTF-8 text strings, or compressed image data, ready to be transmitted to the server.

### Step 3:

The terminal transmits the structured digital input data to the server via a network interface. The terminal constructs a request message that includes user identification information, device identification information, language codes, timestamps, and the captured audio, text, or image data. The terminal then sends the request to a predefined API endpoint on the server through a secure communication channel. The input of this step is the local digital input data along with metadata, and the output of this step is a network packet containing the request, delivered to the server.

### Step 4:

The server receives the request from the terminal and parses the payload. The server uses a network stack and a web framework to accept the incoming message, authenticate the user, and validate the payload format. The server extracts the audio data, character information, and image information, if present, and stores them in temporary processing buffers. The input of this step is the network packet from the terminal, and the output of this step is a set of internal data structures representing the raw user input and associated metadata in server memory.

### Step 5:

The server converts audio information into character information when audio data is present. The server calls a speech recognition service by sending the audio buffer and configuration parameters, such as sampling rate and language code, to a speech-to-text API. The server receives a transcription result that includes token sequences and confidence scores, and selects the highest-confidence transcription as the user's utterance. The input of this step is the digital audio buffer and audio metadata, and the output of this step is character information consisting of a text string representing the spoken query.

### Step 6:

The server performs image analysis when image information or video information is present. The server transmits compressed image data to an image analysis API, requesting label detection, object detection, and text recognition. The server then receives a response containing labels with confidence scores, bounding box coordinates, and recognized text fragments. The input of this step is the encoded image or video frame, and the output of this step is feature information, including category labels and object positions, and recognized character information extracted from the image.

### Step 7:

The server normalizes all available user input into a unified textual representation and a set of visual features. The server merges character information obtained from speech recognition, character information obtained directly from the terminal, and recognized character information extracted from images into a single text field, while also storing separate structures for visual feature information. The server may lower-case the text, remove noise tokens, and segment it into sentences or tokens. The input of this step is multiple heterogeneous input forms (spoken text, typed text, OCR text, and visual feature information), and the output of this step is a normalized query text string and a feature vector summarizing image-derived attributes.

### Step 8:

The server retrieves past selection history information and behavior history information for the user from the storage unit. The server queries a database using the user identification information to obtain records of previously selected items, historical queries, interaction logs, and schedule events. The server then copies the relevant records into memory for further processing. The input of this step is the user identification information, and the output of this step is a set of historical data records associated with the user, structured as lists or tables of past interactions.

### Step 9:

The server generates user preference information from the historical data. The server applies statistical processing to count frequencies of categories, compute time-based decay weights, and calculate averages such as typical price range and preferred time-of-day. The server then performs feature extraction by encoding categorical variables into one-hot vectors, embedding item identifiers into dense vectors, and scaling numeric statistics into normalized ranges. The input of this step is the user's past selection history information and behavior history information, and the output of this step is a user preference vector that numerically represents the user's preferences across multiple dimensions.

### Step 10:

The server constructs candidate item feature vectors based on the current context and available items. The server selects candidate items from item catalogs or external services according to the query type (for example, meals, travel, or schedules) and then retrieves attributes such as item category, location, price, and popularity. The server encodes these attributes using the same feature extraction scheme used for user preferences and context, producing a feature vector per candidate. The input of this step is the list of candidate item identifiers and their attributes, and the output of this step is a set of candidate item feature vectors ready for input to a machine learning model.

### Step 11:

The server calculates evaluation values for candidate items by applying a machine learning model. The server concatenates the user preference vector, the context features derived from the normalized query text and visual feature information, and the candidate item feature vector to form a combined input vector for each candidate. The server forwards this vector through a neural network's layers by performing matrix multiplications and activation function evaluations, and then reads out a scalar score from the output layer. The input of this step is the combined feature vector for each candidate, and the output of this step is an evaluation value for each candidate item indicating its suitability for the user and the context.

### Step 12:

The server selects one or more candidate items based on the evaluation values. The server ranks all candidate items in descending order of evaluation value and applies selection logic such as thresholding or top-k selection. The server may also remove candidates that do not meet constraints such as budget or date conditions. The input of this step is the list of candidate items with their evaluation values, and the output of this step is a subset of candidate items chosen as recommended options for use in subsequent generative processing.

### Step 13:

The server generates a prompt sentence for a generative AI model using internal structured data. The server assembles the normalized query text, summarized user preference information, and descriptions of the top-ranked candidate items, including their evaluation values, into a natural language template. The server then produces a complete prompt sentence that instructs the generative AI model on its role, the context, and the required output style. The input of this step is the normalized query text, the user preference vector, the selected candidate items, and their evaluation values, and the output of this step is a prompt sentence in plain text formatted for input to the generative AI model.

### Step 14:

The server transmits the prompt sentence to the generative AI model and obtains response information. The server uses a client library to invoke an API of the generative AI service, sending the prompt sentence along with parameters such as temperature, maximum tokens, and response format. The remote service processes the prompt and returns generated text. The server receives the response, parses out the main message, and optionally extracts structured pieces such as recommended item names or time expressions. The input of this step is the prompt sentence and model configuration parameters, and the output of this step is response information consisting of generated natural language text and, in some cases, structured data.

### Step 15:

The server generates explanation information or proposal information based on the response information and the selected candidate items. The server aligns text segments from the response information with candidate items using item names or identifiers, and ensures consistency between the generated text and the machine learning evaluation results. The server then constructs a response object that contains the final explanation text, references to specific candidate items, and any additional metadata needed for display or scheduling. The input of this step is the response information from the generative AI model and the list of selected candidate items, and the output of this step is output information formatted for delivery to the terminal.

### Step 16:

The server transmits the output information to the terminal. The server serializes the explanation text, proposal details, item identifiers, and optional reminder texts into a response message and sends it through the network interface. The server may include structured fields for display elements such as titles, subtitles, and button labels. The input of this step is the formatted output information, and the output of this step is a network response packet delivered to the terminal that encapsulates the recommendation or reminder data.

### Step 17:

The terminal receives the output information and presents it to the user. The terminal parses the response, extracts the explanation text and candidate item details, and renders them in the graphical user interface as text blocks, lists, or interactive cards. If voice output is enabled, the terminal uses a text-to-speech engine to synthesize speech from the explanation text and plays it through the speaker. The input of this step is the network response packet from the server, and the output of this step is a visual and/or auditory presentation of the recommendation, explanation, or reminder to the user.

### Step 18:

The user reviews the presented information and performs a final selection or a follow-up action. The user selects one of the recommended items, confirms a suggested schedule, or rejects the options and issues a new query. The input of this step is the displayed explanation information and candidate options, and the output of this step is a user action, such as a tap, click, or voice command that indicates acceptance, rejection, or modification of the proposal.

### Step 19:

The terminal captures the user's final selection or follow-up command and sends it to the server. The terminal records the identifier of the chosen candidate item, any additional user parameters (for example, quantity or date confirmation), and context information such as time and location. The terminal forms a new request message that includes this final selection information and transmits it to the server. The input of this step is the user's interaction on the interface, and the output of this step is a structured final selection message sent over the network.

### Step 20:

The server records the final selection information in the storage unit and updates the user preference information. The server writes a new history record containing the user identifier, the selected candidate item identifier, and context attributes to the past selection history dataset. The server also updates summary statistics, such as category frequencies and recency scores, to reflect the new choice, and may recompute the user preference vector or mark it for recalculation. The input of this step is the final selection message from the terminal, and the output of this step is an updated set of history records and an updated or flagged user preference vector stored in the storage unit.

### Step 21:

The server optionally uses the newly recorded data to retrain or fine-tune the machine learning model. The server compiles recent final selection records into training examples, computes loss values based on differences between predicted evaluation values and observed selections, and applies gradient-based updates to model parameters. The input of this step is the batch of newly collected final selection information and existing model parameters, and the output of this step is an updated set of model weights and biases that improve future evaluation value predictions and personalization performance.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional voice-based assistant systems typically execute a fixed sequence of operations in which speech recognition converts an utterance to text, a simple intent classifier selects one of several pre-defined functions, and a template-based engine generates a response. In such systems, the logic for selecting functions and generating responses is tightly hard-coded, and the textual input given to any downstream generative component, if present at all, is not systematically structured from user-specific data such as schedule records, usage history, or behavioral tendencies. As a result, these systems often produce generic answers that fail to reflect the user's current context, past behavior, or preferred style of interaction.

In addition, in many existing architectures, the text that is provided to a generative AI model is merely a direct transcription of the user's utterance, optionally concatenated with unstructured notes. This limits the ability of the generative AI model to perform effective reasoning over structured information such as calendar entries, historical travel records, or preference profiles. Without a mechanism to transform raw database records and recognized intent into a well-formed prompt sentence that encodes structured data and clear output requirements, the generative AI model may generate incomplete, inconsistent, or overly verbose responses, thereby degrading the overall user experience.

Furthermore, conventional systems do not dynamically adapt the construction of prompts for a generative AI model in light of learned user behavior. Even if user behavior history is stored, it is rarely used to alter the components, constraints, or expression style of prompts in a systematic way. This prevents the system from improving over time in terms of response relevance, conciseness, and presentation style, and leads to inefficiencies in processing and wasted computational resources on repeated, unoptimized prompt patterns.

Moreover, prior systems that handle schedule management, recommendation generation, and voice interaction often treat these functions as separate pipelines. Schedule retrieval may be implemented as a simple database query followed by rule-based phrasing, while recommendations may be generated by separate heuristics, without a unified mechanism for summarizing schedule information or recommendation content via a generative AI model. As a consequence, it is difficult to provide coherent, high-quality natural language summaries and reminders that simultaneously exploit both structured user data and powerful generative models.

Accordingly, there is a need for an improved computer-implemented system and method that (i) converts voice input into text, (ii) performs natural language processing to determine user intent, (iii) selects among multiple function modules including at least schedule management and proposal generation, (iv) converts user-specific record information and history information into structured data, and (v) constructs optimized prompt sentences that integrate such structured data, user intent, and response format instructions for input to a generative AI model. There is a further need for such a system to dynamically adapt prompt construction based on learned user behavior, and to generate, via a generative AI model, concise natural language summaries and reminders which are then converted into synthesized speech. By improving the manner in which the computer system structures and supplies information to the generative AI model, the overall efficiency, accuracy, and usefulness of the computer system can be significantly enhanced.

The specific processing by the specific processing unit 290 of the data processing device 12 in Example 2 is realized by the following means.

The present invention provides a server comprising a processor configured to receive, via a terminal device, voice input from a user and convert the voice input into character information by performing speech recognition processing; to perform natural language processing on the character information to extract an intention of the user and, based on the intention, to select, from among a plurality of function modules, at least a schedule management function module and a proposal generation function module; to, when the schedule management function module is selected, acquire record information associated with the user from a storage device and extract schedule information based on time information included in the record information; to, when the proposal generation function module is selected, acquire history information and attribute information associated with the user from the storage device and generate structured data including the history information and the attribute information; to generate a prompt sentence including at least one of the schedule information and the structured data, the intention of the user, and an instruction regarding a response format, and to input the prompt sentence into a generative AI model to cause the generative AI model to generate response information expressed in natural language; and to execute speech synthesis processing based on the response information, generate audio data, and transmit the audio data to the terminal device to present the audio data to the user. This enables the computer system to internally restructure user-specific data and recognized intent into optimized prompt sentences, thereby improving the technical operation of the generative AI model, enhancing relevance and coherence of generated responses, and providing more efficient, context-aware voice-based interaction.

The term “processor” refers to a hardware or virtual computation unit, such as a central processing unit or a set of processing cores, that executes program instructions to perform the operations described in the system.

The term “terminal device” refers to an information processing apparatus operated by a user, including at least an input interface and an output interface, that communicates with the server to transmit voice input and receive audio data.

The term “voice input” refers to an acoustic signal generated by speech of the user and captured by an audio input component of the terminal device.

The term “character information” refers to digital text data obtained by converting the voice input into a sequence of characters or tokens using speech recognition processing.

The term “speech recognition processing” refers to a computational procedure that analyzes the voice input, extracts acoustic features, and outputs corresponding character information representing a transcription of the spoken content.

The term “natural language processing” refers to a computational analysis procedure that processes character information expressed in a human language to extract linguistic or semantic information, including at least user intention and time expressions.

The term “intention of the user” refers to a semantic representation of a purpose, request, or command contained in the character information, determined by the natural language processing.

The term “function module” refers to a software component or logical unit executable by the processor, configured to perform a particular type of processing, such as schedule management or proposal generation, in response to the intention of the user.

The term “schedule management function module” refers to a function module that retrieves, analyzes, and outputs schedule-related information associated with the user based on record information stored in a storage device.

The term “proposal generation function module” refers to a function module that generates recommendations or proposals, including at least travel-related or item-related suggestions, using history information and attribute information associated with the user.

The term “storage device” refers to a physical or logical data storage resource, such as a memory device or a persistent storage unit, configured to store record information, history information, attribute information, and other data used by the processor.

The term “record information” refers to structured or semi-structured data associated with the user, including at least schedule entries that include time information and content information.

The term “schedule information” refers to a subset of record information that is selected or extracted based on time information and represents appointments, events, or tasks associated with the user.

The term “time information” refers to data indicating at least one of a date, a time, a time period, or a temporal relationship used to associate schedule information with specific time points or intervals.

The term “history information” refers to data indicating past activities, usage, preferences, or interactions of the user, which may include past travel records, content access history, or other behavioral logs.

The term “attribute information” refers to data representing static or relatively stable characteristics of the user, including at least preference attributes, profile attributes, or classification attributes related to the user.

The term “structured data” refers to data that is arranged according to a predetermined format or schema, such as a table structure or a hierarchical structure, enabling systematic interpretation by the processor or by a generative AI model.

The term “prompt sentence” refers to a character string, including instructions and contextual data, that is generated by the processor and provided as an input to a generative AI model to cause the generative AI model to generate response information.

The term “response format” refers to specifications included in the prompt sentence that define how the response information is to be generated, including at least constraints on content, structure, length, style, or language.

The term “generative AI model” refers to an information processing model, implemented by machine learning or statistical techniques, that generates new text or other data in response to a given input, including at least a large-scale neural network model configured to output natural language text based on a prompt sentence.

The term “response information” refers to natural language text generated by the generative AI model based on the prompt sentence, the schedule information, and the structured data, and intended to be presented to the user.

The term “speech synthesis processing” refers to a computational procedure that converts response information expressed as text into audio data representing synthesized speech.

The term “audio data” refers to digital data representing an audio waveform that is generated by the speech synthesis processing and is suitable for playback on the terminal device.

The term “behavior history information” refers to accumulated data representing a sequence of past actions, selections, or interactions of the user with the system or related services.

The term “usage tendency information” refers to data derived from analysis of the behavior history information that indicates patterns or preferences of the user, such as frequently requested functions, preferred expression styles, or timing of use.

The term “learning result” refers to a set of parameters, models, or derived data obtained by applying a learning algorithm to the behavior history information and the usage tendency information, used for subsequent processing.

The term “components of the prompt sentence” refers to elements included in the prompt sentence, such as user context, structured data, instructional phrases, constraints, and formatting directives.

The term “output conditions” refers to rules or constraints, specified in or derived for the prompt sentence, that control the content, detail level, style, or length of the response information generated by the generative AI model.

The term “expression styles” refers to stylistic characteristics of the response information, including at least politeness level, tone, formality, and layout in natural language.

The term “time expression” refers to a phrase or token contained in the character information that indicates a temporal concept, such as “today,” “tomorrow,” or a specific date, detected by the natural language processing.

The term “target period” refers to a time range determined by interpreting at least one time expression extracted from the character information and used to select schedule information relevant to that time range.

The term “summary explanation” refers to a compressed natural language representation of schedule information or other structured data that omits details while preserving key information for user comprehension.

The term “reminder content” refers to natural language text generated to notify the user of future events, tasks, or deadlines based on the schedule information and the target period.

In one embodiment, a server cooperates with at least one terminal and at least one user to implement the claimed system. The server includes a processor, a main memory, a non-volatile storage device such as a solid-state drive, and a network interface. The terminal includes at least a central processing unit, a memory, an audio input device such as a microphone, an audio output device such as a speaker or earphone, and a wireless or wired communication interface. The user operates the terminal and provides voice input.

The terminal executes an operating system, such as a mobile operating system or a desktop operating system, and provides an application that communicates with the server via a secure communication protocol. The terminal converts an analog audio signal captured by the microphone into digital audio data using an analog-to-digital converter and stores the digital audio data in a buffer region of the terminal's memory. The terminal encodes the digital audio data in a standard audio format and transmits the audio data to the server over a network using a transport protocol.

The server executes a server-side operating system and an application framework that implements the system functions. The server stores executable programs and configuration data in the storage device, and loads frequently used code and data into main memory. The processor of the server fetches and executes instructions from main memory to perform the operations described in the claims.

The server converts the received audio data into character information by executing a speech recognition algorithm. In one embodiment, the server uses a deep neural network-based acoustic model in combination with a statistical or neural language model. The acoustic model may be implemented as a multi-layer neural network, such as a convolutional neural network, a recurrent neural network, or a transformer-based encoder, that receives frames of spectral features (e.g., mel-frequency cepstral coefficients) as input and outputs a probability distribution over phonetic units. The language model may be implemented as an n-gram language model or a recurrent or transformer-based model that predicts sequences of characters or word units. The server combines the outputs of the acoustic model and the language model using a decoding algorithm, such as a beam search with a weighted finite state transducer, to determine the most probable sequence of characters that corresponds to the user's utterance. By performing this conversion automatically and consistently, the server reduces transcription errors and provides stable input for subsequent natural language processing.

The server performs natural language processing on the generated character information to extract an intention of the user. In one embodiment, the server tokenizes the character string into tokens, assigns part-of-speech tags, and identifies named entities using a natural language processing library. The server then applies an intent classification model implemented as a neural network, such as a bidirectional transformer-based model pre-trained on large corpora and fine-tuned on domain-specific intent labels. The intent classification model receives an encoded representation of the token sequence, computes attention-based contextual embeddings, and outputs a probability distribution over predefined intent categories, including at least a schedule management intent and a proposal generation intent. The server selects an intent whose probability exceeds a threshold and identifies a corresponding function module.

The server executes a schedule management function module when the extracted intention corresponds to schedule-related queries. The server accesses a storage device that stores record information associated with the user. The record information may be stored in a relational database or a key-value store, and includes at least time information, such as dates and time ranges, and descriptive content, such as event titles and locations. The server retrieves record information by issuing a query that specifies the user identifier and one or more conditions derived from the recognized intention. The server can use a time expression parser implemented as rules and a trained model to convert expressions such as “today,” “tomorrow,” or “next Monday” into explicit date ranges. The server then filters the record information to obtain schedule information corresponding to the target period. The schedule information is represented as structured data, for example as a list of entries each including normalized time information and event content.

The server executes a proposal generation function module when the extracted intention corresponds to recommendation or proposal-related queries. The server accesses history information and attribute information associated with the user stored in the storage device. The history information may include past travel data, past content access data, purchase records, or prior recommendation acceptance data, each associated with time stamps and classification tags. The attribute information may include user preferences, demographic attributes, budget ranges, and usage constraints. The server converts the raw history information and attribute information into structured data by mapping them into a canonical schema that includes fields such as “location,” “duration,” “liked_features,” “budget_category,” and “travel_mode.” The server may perform aggregation and normalization, such as counting frequencies of visited categories and computing typical budget ranges, to reduce noise and standardize inputs.

The server constructs a prompt sentence for a generative AI model based on at least one of the schedule information and the structured data, together with the extracted intention of the user and an instruction regarding a response format. The server generates the prompt sentence in a deterministic and rule-based manner to ensure that all necessary contextual information is explicitly provided to the generative AI model. For a schedule management query, the server may generate a prompt sentence such as:
“The user asked: ‘Tell me my schedule for tomorrow.’
Here is the user's schedule for tomorrow:
10:00-11:00, Team meeting
15:00-16:00, Client call
You are a personal assistant. Please summarize the schedule for tomorrow in one or two concise English sentences.”

For a travel proposal query, the server may generate a prompt sentence such as:
“The user requested: ‘Make a travel suggestion.’
The user's past travel history is:
3-day trip to Kyoto, enjoyed temples and staying at traditional inns.
4-day trip to Okinawa, enjoyed beaches and snorkeling.
The user wants a new 3-day, 2-night trip departing from Tokyo with a medium budget.
Please propose:
1. A travel destination in Japan.
2. Recommended transportation method.
3. Recommended accommodation type.
4. Two or three recommended activities.
Answer in English in a friendly tone.”

The server generates such prompt sentences using templates that define fixed instructional segments and variable segments filled with structured data fields. The server thereby separates the logic of data retrieval from the logic of instruction construction and uses specific rules to map database records and intent information into human-readable prompt content. This structured prompt construction differs from simple passing of the raw transcription to a generative model and leads to more deterministic and efficient use of the generative AI model.

The server supplies the constructed prompt sentence to a generative AI model. In one embodiment, the generative AI model is implemented as a large-scale transformer-based neural network containing an embedding layer that converts tokens into dense vectors, a plurality of attention layers that compute self-attention over token positions, and an output layer that maps hidden states to token probability distributions. The generative AI model stores parameters, such as weight matrices and bias vectors, in a model storage. During inference, the server tokenizes the prompt sentence, feeds the tokens into the generative AI model, and iteratively computes attention and feed-forward operations across multiple layers to generate new tokens representing the response information. The generative AI model uses mechanisms such as multi-head attention and positional encoding to capture long-range dependencies and ordering in the prompt sentence.

The server can adjust inference parameters, such as maximum output length, temperature, and probability thresholds, to control diversity and determinism of the generated text. By embedding structured data and specific response format instructions into the prompt sentence, the server constrains the generative AI model's output space, which reduces unnecessary computation and improves accuracy of the generated responses. The server obtains the generated natural language text as response information and stores it temporarily in memory.

The server performs post-processing on the response information. The server may remove undesired prefixes, check for content policy violations, normalize formatting, and resolve references to schedule entries into explicit times. The server then performs speech synthesis processing. In one embodiment, the server uses a neural text-to-speech model that converts character sequences into mel-spectrogram representations and then converts the spectrograms into waveforms using a vocoder neural network. The text-to-speech model may be a sequence-to-sequence model with attention, which learns to align text tokens with acoustic frames. Alternatively, the server may use a parametric or concatenative synthesis engine configured with voice parameters. The server thereby generates audio data suitable for playback on the terminal.

The terminal receives the audio data, stores it in a buffer, and uses an audio playback interface to output the audio data through the speaker. The user hears a synthesized spoken response that reflects both the content of the schedule or proposal and the style specified in the prompt sentence.

The server dynamically changes components, output conditions, and expression styles of the prompt sentences based on a learning result derived from behavior history information and usage tendency information of the user. The server collects logs of user interactions, including which prompts were generated, which responses were presented, and which responses led to follow-up interactions. The server stores these logs in a dedicated data structure. The server then applies a learning algorithm, such as supervised learning or reinforcement learning, to update prompt selection policies or template parameters. For example, the server can train a model that maps features of the user context and past interactions (including time of day, type of query, and user correction behavior) to preferred prompt patterns (e.g., shorter or longer explanations, more or fewer bullet points, or inclusion of additional constraints).

The server may implement the learning algorithm as a neural network or as a gradient-boosted decision tree that outputs scores for different prompt templates. The server uses an objective function that rewards higher user engagement, accuracy of follow-up tasks, or decreased need for user correction. By updating internal parameters that influence which components of the prompt sentence are included and how the response format is specified, the server optimizes the configuration of prompt sentences for the generative AI model. This adaptation process is not a simple automation of manual drafting of prompts; rather, it uses statistical patterns in large amounts of interaction data to modify, in a non-obvious way, the composition of instructions and structured data passed to the generative AI model. As a result, the system improves computation efficiency and reduces token usage in prompts while maintaining or improving accuracy of responses.

The server improves computer technology by reducing processing time, improving accuracy of intent detection and response generation, and decreasing unnecessary network traffic. Because the server extracts structured data from databases and encodes only relevant segments of that data into the prompt sentence, the size of the prompt is smaller than an unfiltered concatenation of all available records. This reduction in input size leads to reduced computational load in the generative AI model, which has a computational complexity that grows with the square of the sequence length in transformer architectures. Therefore, the structured prompt construction directly reduces inference cost and latency. Additionally, by converting temporal expressions into normalized date ranges and constructing schedule summaries via the generative AI model, the server improves the consistency and correctness of schedule responses, reducing user confusion and repeated queries, which in turn reduces overall network traffic and server workload.

The server also improves data management by maintaining a clear separation between raw record information, history information, and derived structured data. The server stores structured data in a normalized form that facilitates efficient indexing and retrieval. When constructing prompt sentences, the server uses predefined field mappings and template rules, which reduces risk of programming errors and enables modular extension. For example, the server can add a food recommendation function module or a general information function module without altering the core pipeline of converting recognized intentions and structured data into prompt sentences.

The system processes data using algorithms and data structures that are not performed in human mental processes. Humans do not manually compute attention weights over high-dimensional embeddings, perform beam search across thousands of candidate texts, or dynamically optimize token usage in prompts based on long-term behavioral statistics. The server uses a combination of neural network-based models, probabilistic decoders, and rule-based template composition to perform operations that require a large number of arithmetic operations and vector computations that are impractical to perform manually.

In an alternative embodiment, the server deploys the generative AI model locally instead of using a remote model service. The server loads the model parameters into graphics processing units or specialized accelerators, partitions the model into layers across devices if necessary, and performs the transformer computations locally. In another embodiment, the server switches between different generative AI models in response to resource constraints, such as using a smaller model at peak times. The prompt construction process remains the same, but the server adjusts output length and temperature parameters to keep latency within a target range.

In another embodiment, the server supports multiple languages. The server detects the language of the character information using a language identification model and selects language-specific template sets and generative AI model instances. The structured data representation remains language-neutral, and only the prompt sentences and responses are language-specific. This modular design allows efficient support for multilingual environments without duplicating underlying data structures.

In another embodiment, the server extends the proposal generation function module to cover domains such as education, health guidance, or device control. The server still uses history information and attribute information but changes the domain-specific fields and template instructions. For example, the server may generate a prompt sentence such as:
“The user requested: ‘Recommend a study plan for this week.’
The user's past learning history is:
Completed beginner level programming course.
Studied 3 hours per week on average in the last month.
The user wants a weekly study plan with 1 hour per day.
Please propose a detailed 7-day study schedule in English, including topics and approximate time per topic.”

The processing pipeline remains the same, and the server continues to use structured data plus deterministic template rules to form prompt sentences, maintaining the same technical effects of improved efficiency and accuracy.

In yet another embodiment, the server introduces rule-based post-filtering of the generative AI model's output. The server analyzes the generated response information using a lightweight rule engine to detect missing schedule items or incomplete recommendations. If a deficiency is detected, the server can re-generate a refined prompt sentence that includes an additional instruction such as “Ensure that all events in the list are covered in the summary” or “Include at least one indoor and one outdoor activity,” and resubmit the refined prompt sentence to the generative AI model. This multi-stage prompting and checking mechanism further improves reliability and reduces errors in the generated responses.

As described, the system integrates specific data structures, neural network-based models, rule-based templates, and adaptive learning mechanisms to form an improved computer-implemented system. The server does not merely automate human verbal tasks, but rather reorganizes and transforms data internally in ways that optimize computation, reduce latency, and improve output quality, thereby achieving concrete technical effects in the operation of the computer system.

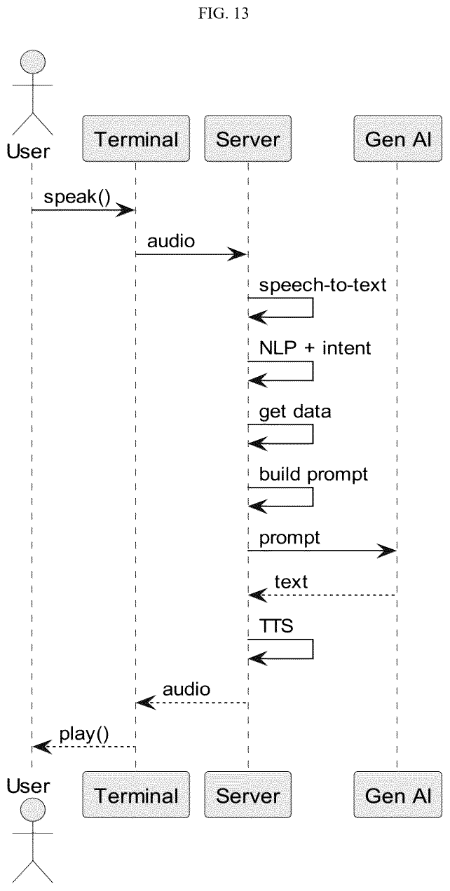

The following describes the processing flow using FIG. 13.

### Step 1:

The user provides voice input. The user speaks a natural-language utterance toward the terminal, such as “Tell me my schedule for tomorrow” or “Make a travel suggestion.” The input of this step is an analog audio signal produced by the user's speech, and the output is an acoustic waveform captured by the terminal's microphone. No data processing is performed by the user, and the user simply generates the sound that will be processed by the terminal.

### Step 2:

The terminal captures and digitizes the voice input. The terminal receives the analog audio signal from the microphone and uses an analog-to-digital converter to sample the signal at a specified rate (for example, 16 kHz, 16-bit mono). The input is the analog audio waveform, and the output is a sequence of digital samples stored in a buffer in the terminal's memory. The terminal performs data processing by converting continuous-time audio into discrete digital frames and optionally encoding the frames into a standardized audio format such as linear PCM or a compressed codec.

### Step 3:

The terminal packages the audio data and transmits it to the server. The terminal constructs a request message that includes the encoded audio data and metadata such as a user identifier, a timestamp, and a language code. The input to this step is the buffered digital audio data and associated metadata; the output is a network packet stream transmitted over a secure communication channel to the server. The terminal performs data processing by encapsulating the audio bytes and metadata into a request structure, applying encryption and framing required by the communication protocol.

### Step 4:

The server receives the audio request and validates it. The server accepts the incoming request through a network interface and extracts the audio payload and metadata. The input is the received network packet stream, and the output is a validated audio data object stored in server memory or temporary storage. The server performs data processing by verifying authentication tokens, checking content length and format, and rejecting or logging malformed requests before passing valid audio data to the next stage.

### Step 5:

The server normalizes the audio data for speech recognition. The server takes the validated audio data as input and converts it into a standardized internal format required by a speech recognition engine. The input is the raw or encoded audio data, and the output is a normalized audio buffer with a fixed sampling rate, channel configuration, and bit depth. The server performs data processing by decoding compressed formats if necessary, resampling the waveform, converting stereo to mono, and trimming leading and trailing silence segments using a voice activity detection algorithm to reduce the amount of audio to be processed.

### Step 6:

The server converts the normalized audio into character information. The server inputs the normalized audio buffer into a speech recognition engine implemented as a combination of an acoustic model and a language model. The input to this step is the normalized audio buffer; the output is a character string representing a transcription of the user's utterance. The server performs data processing by computing acoustic features (e.g., mel-frequency cepstral coefficients) over successive frames, feeding the features into a neural acoustic model that outputs probability distributions over phonetic units, combining these with a language model using a decoding algorithm such as beam search, and selecting the most probable sequence of characters or word tokens.

### Step 7:

The server performs natural language preprocessing on the character string. The server receives the transcribed character string as input and produces a structured representation suitable for intent analysis. The input is the raw transcription text, and the output is a tokenized, annotated representation that may include part-of-speech tags and recognized entities. The server performs data processing by splitting the text into tokens, normalizing case and punctuation, assigning syntactic categories, and identifying temporal expressions, named entities, and other semantic markers using rule-based and statistical natural language processing components.

### Step 8:

The server determines the user's intention and selects a function module. The server takes the annotated representation as input and generates an intent label and a module selection result as output. The input is the tokenized and annotated text, and the output is an intent category (e.g., schedule query, proposal generation) and an identifier of a corresponding function module (e.g., schedule management function module or proposal generation function module). The server performs data processing by encoding the tokens into vector embeddings, passing the sequence through an intent classification neural network, computing a probability distribution over intent classes, selecting the class with the highest probability that exceeds a threshold, and mapping the selected class to a predefined module.

### Step 9:

The server retrieves user-related data from storage based on the selected module. The server receives the intent label and module identifier as input and outputs structured user-related data. For a schedule management function module, the input is a user identifier and a time-related expression; the output is schedule information consisting of events relevant to the target period. For a proposal generation function module, the input is the user identifier and context; the output is structured history information and attribute information. The server performs data processing by constructing database queries, executing them against a storage device, filtering results by user ID and time or preference criteria, and organizing the retrieved records into intermediate data structures.

### Step 10:

The server converts raw record information into normalized schedule information. When the schedule management function module is selected, the server receives record information including time fields and event descriptions as input and generates schedule information normalized to a consistent time representation. The input is a set of raw schedule records; the output is a list or array of schedule entries with standardized date-time formats and concise labels. The server performs data processing by parsing time fields, resolving relative expressions (e.g., “tomorrow”) into absolute dates using the current server time and the user's timezone, discarding records outside the specified period, and sorting remaining entries by time.

### Step 11:

The server converts history information and attribute information into structured data for proposals. When the proposal generation function module is selected, the server receives history information and attribute information as input and outputs structured data adapted to the generative AI model. The input is raw logs and profile records; the output is a normalized set of fields such as destinations, durations, liked features, and budget categories. The server performs data processing by aggregating repeated categories, computing metrics such as average duration or typical budget, mapping free-text descriptions to controlled vocabularies, and encoding the resulting attributes into a canonical schema.

### Step 12:

The server constructs a prompt sentence that integrates structured data and response instructions. The server receives as input the extracted intention, the schedule information and/or structured data, and configuration rules defining desired response formats. The output is a prompt sentence expressed as a human-readable text that will be supplied to the generative AI model. The server performs data processing by selecting a template corresponding to the identified intent, filling template slots with textual representations of schedule entries or user history, appending explicit instructions for output length, style, and structure, and concatenating all segments into a single coherent text. For example, the server may generate:
“The user asked: ‘Tell me my schedule for tomorrow.’
Here is the user's schedule for tomorrow:
10:00-11:00, Team meeting
15:00-16:00, Client call
You are a personal assistant. Please summarize the schedule for tomorrow in one or two concise English sentences.”

### Step 13:

The server sends the prompt sentence to the generative AI model and receives response information. The server inputs the constructed prompt sentence into a generative AI model and obtains natural language output. The input is the prompt sentence text; the output is response information in the form of generated text. The server performs data processing by tokenizing the prompt into subword tokens, passing the token sequence through a transformer-based neural network that repeatedly applies attention and feed-forward computations layer by layer, sampling or selecting output tokens according to configured parameters such as temperature and maximum length, and decoding the output tokens into a character string that forms the response.

### Step 14:

The server post-processes the generated response information for clarity and compliance. The server receives the raw generated text as input and produces a refined text result as output. The input is the unedited response information; the output is a normalized string suitable for speech synthesis and presentation. The server performs data processing by removing extraneous phrases (such as apologies or disclaimers if not desired), ensuring that all schedule items or requested elements are covered, normalizing formats for times and dates, and checking the text against rule-based filters to avoid disallowed content.

### Step 15:

The server converts the refined text into audio data through speech synthesis. The server takes the refined text as input and outputs a digital audio waveform. The input is the final response text; the output is audio data encoded in a format playable by the terminal, such as PCM or a compressed audio stream. The server performs data processing by first normalizing text into a phonetic sequence and prosody pattern, using a text-to-speech model to predict acoustic features such as mel-spectrogram frames, then converting these features into waveform samples using a vocoder algorithm. The server packages the resulting samples into an audio file or stream with associated headers.

### Step 16:

The server transmits the synthesized audio data to the terminal. The server receives the generated audio data as input and produces one or more network responses addressed to the terminal as output. The input is the audio byte sequence and related metadata; the output is encrypted packets containing the audio payload and headers indicating format and length. The server performs data processing by attaching appropriate response codes, setting content-type fields, fragmenting the audio data into packets according to network protocol requirements, and dispatching the packets via the network interface.

### Step 17:

The terminal receives and buffers the synthesized audio data. The terminal accepts the incoming network response as input and produces a buffered audio stream ready for playback as output. The input is the network packets containing the audio payload; the output is a contiguous audio buffer stored in memory or local storage. The terminal performs data processing by validating the response status, reassembling packets into the original audio byte sequence, optionally decoding compressed formats into raw samples, and preparing an audio playback object with appropriate configuration parameters such as sample rate and channel count.

### Step 18:

The terminal plays back the audio to the user. The terminal takes the buffered audio stream as input and outputs an analog audio signal through the speaker that reaches the user. The input is the digital audio samples; the output is sound waves corresponding to the synthesized speech. The terminal performs data processing by sending the samples to the audio driver, which feeds them to a digital-to-analog converter, amplifies the resulting analog signal, and drives the speaker membrane to produce audible responses. The user then hears the spoken summary of the schedule or the proposed suggestion and can act on the information or provide a follow-up voice input.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional interactive information systems that accept user speech and return recommendations typically implement a pipeline in which speech is transcribed, intent is classified, and predefined rules or static machine learning models are invoked. In such systems, several technical limitations arise.

First, the processing pipeline treats automatic speech recognition, intent understanding, user state estimation, and response generation as largely independent components connected by narrow, fixed interfaces. As a result, intermediate context such as user behavior history, multimodal observations, and emotional state is either discarded or only partially used. This leads to sub-optimal use of available computation and storage resources, because the system repeatedly queries separate models and databases without a unified representation, and must maintain multiple bespoke logic paths for each application domain.

Second, known systems that employ generative AI models generally pass only the raw user utterance or a simple intent label as input, without constructing a structured, context-rich prompt sentence. This under-utilizes the capabilities of generative models and forces additional rule-based post-processing to correct or constrain the generated outputs. The lack of a systematic mechanism for synthesizing internal state, including user history and emotion, into a single prompt sentence causes instability in output quality, increased latency due to multiple correction rounds, and difficulty in reliably scaling to new domains.

Third, most existing architectures do not continuously adapt the structure of the prompts or the selection of features included in prompts based on actual user behavior. While some systems record user choices for analytics, they do not feed this behavior back into a learning mechanism that directly optimizes the internal data representation and prompt construction logic. This results in a rigid, manually-tuned pipeline that is expensive to maintain and that cannot efficiently improve over time with real usage data.

Fourth, conventional systems typically perform recommendation and scheduling logic via domain-specific rule engines or isolated recommendation models, and then optionally “wrap” the result in natural language. This separation of logic and language complicates the integration of multimodal context such as current emotion or vision-based scene understanding into the recommendation process, and often requires duplicated logic in different code paths (for example, for speech responses and visual responses). It also makes it difficult to implement unified optimization and ranking processes across heterogeneous information sources.

Therefore, there is a need for an improved computer-implemented system that (i) unifies audio, language, image, history, and emotion information into an internal information data structure, (ii) automatically transforms that structure into a well-formed prompt sentence for a generative AI model, (iii) uses the outputs of the generative AI model in combination with local history and external information resources in a dedicated optimization process, and (iv) continuously adapts the internal information structure and prompt formulation on the basis of user behavior history. Such a system should improve the efficiency, robustness, and scalability of multimodal, emotion-aware recommendation and schedule support on a computing platform.

The specific processing by the specific processing unit 290 of the data processing device 12 in Application Example 2 is realized by the following means.

The present invention provides a server comprising a processor configured to acquire audio information and convert the audio information into language information, to analyze the language information together with image information in order to extract feature information regarding an object or a situation from the image information and to extract a request content of a user from the language information, to estimate an emotional state of the user on the basis of at least one of the audio information and the language information, to generate internal information data including at least the request content, the feature information, the emotional state, and user history information, to generate a prompt sentence describing the internal information data in natural language and to input the prompt sentence into a generative AI model so as to acquire proposal information from the generative AI model, to compare the proposal information with the user history information and with external information resources and perform an optimization process for selecting or ranking the proposal information, and to generate visual presentation information or acoustic presentation information on the basis of a result of the optimization process and present the visual presentation information or the acoustic presentation information to the user. This enables the computing system to internally integrate multimodal context and user state into a unified data structure, to systematically leverage a generative AI model through a context-rich prompt sentence, to refine generated proposals using local and external data in a dedicated optimization stage, and to provide more accurate and adaptive recommendations and schedule-related information with improved computational efficiency and extensibility.

The term “audio information” refers to digital data representing sound signals captured from a user, including but not limited to voice signals, that can be processed by a computing device.

The term “language information” refers to text data obtained by converting audio information into a character-based representation, and may include recognized words, phrases, and sentences in a natural language.

The term “image information” refers to digital data representing still or moving visual content, including but not limited to photographs, video frames, and other pixel-based data structures.

The term “feature information” refers to abstracted data derived from image information or other sensor inputs, indicating properties of an object or a situation, such as detected categories, attributes, locations, or scene types.

The term “request content” refers to information indicating the intent or purpose of a user's input, including, for example, a request for a recommendation, an inquiry about a schedule, or an instruction to perform a specific operation.

The term “emotional state” refers to data representing an estimated psychological or affective condition of a user, such as stress, fatigue, relaxation, excitement, or other emotion categories, derived from analysis of audio information, language information, or other signals.

The term “internal information data” refers to a structured data set generated within the server, including at least the request content, feature information, emotional state, and user history information, and serving as an intermediate representation for further processing.

The term “user history information” refers to stored data relating to past interactions, behaviors, or preferences of a user, including but not limited to prior selections, ratings, orders, viewing records, and usage patterns.

The term “prompt sentence” refers to a natural-language text constructed from the internal information data, which is formatted to be input into a generative AI model in order to obtain proposal information.

The term “generative AI model” refers to a parameterized information processing model that receives a prompt sentence as input and outputs generated information, such as recommendations, summaries, or candidate content, based on learned statistical relationships.

The term “proposal information” refers to result data output by the generative AI model in response to a prompt sentence, including, for example, recommended items, candidate plans, generated texts, or other suggested content.

The term “external information resources” refers to data sources outside the internal information data store, including remote databases, service interfaces, content catalogs, schedule repositories, or other external systems accessible by the server.

The term “optimization process” refers to processing by which proposal information is evaluated, selected, filtered, or ranked based on comparison with user history information and external information resources, in order to determine proposal information to be presented to the user.

The term “visual presentation information” refers to data formatted for display on a user interface, including but not limited to text, icons, images, lists, or graphical elements representing proposal information or related content.

The term “acoustic presentation information” refers to data formatted for audio output, including synthesized speech signals or other audio signals that convey proposal information or related content to the user.

The term “behavior history” refers to a subset of user history information that records user reactions to proposal information, including at least selection information, non-selection information, confirmations, or cancellations in response to presented proposals.

The term “machine learning processing” refers to computational procedures that adjust parameters of a model or algorithm based on training data, including behavior history, in order to improve performance of tasks such as prediction, classification, or ranking.

The term “learning optimization process” refers to processing in which behavior history is learned by machine learning processing and results of the learning are used to update elements of the internal information data and description contents of the prompt sentence.

The term “schedule information” refers to structured data representing time-based events or plans of a user, including dates, times, event types, participants, and related metadata, which can be acquired from or stored in a schedule management resource.

The term “external schedule management resource” refers to a hardware or software resource, separate from the internal information data, that stores or manages schedule information for a user and that can be accessed by the server to acquire or update schedule information.

In one embodiment, a server, a terminal, and a user cooperate to implement the claimed system.

### A. Overall Hardware and Software Configuration

The server comprises at least one processor, a main memory, a non-volatile storage device, a network interface, and an input/output interface. The processor executes an operating system such as a server-class operating system and application software implementing the audio acquisition, language processing, image analysis, emotion estimation, internal information data generation, prompt sentence generation, communication with a generative AI model, optimization processing, and presentation processing described in the claims.

The terminal comprises at least one processor, a memory, a microphone, a speaker, a display, and optionally a camera and additional sensors. The terminal executes a client application that captures audio information and image information from the user and transmits such information to the server through a communication network such as the Internet. The terminal also receives visual presentation information and acoustic presentation information from the server and outputs such information via the display and the speaker.

The server uses commercially available cloud-based services and software libraries as specific examples of hardware-implemented functions. The server may use a speech recognition service such as a generic cloud speech-to-text API, a text-to-speech service such as a generic cloud text-to-speech API, a computer-vision library such as a general-purpose image processing library (e.g., an open-source vision library), and an emotion analysis service such as a general-purpose tone analyzer or emotion recognition API. The server may use a machine learning framework such as a general-purpose tensor computation and neural network library to implement custom models for intent classification, emotion estimation, and recommendation ranking. The server may access an external calendar service such as a generic calendar API for schedule management, and external content or service providers through standardized web APIs.

### B. Acquisition and Conversion of Audio Information

The user utters speech toward the terminal. The terminal activates the microphone, samples the user's voice as an analog signal, applies analog-to-digital conversion, and stores the resulting audio information as a sequence of digital samples (for example, linear PCM at a sampling rate of 16 kHz with 16-bit resolution). The terminal encodes the audio information in a standard container format, attaches metadata such as language code, time stamp, and user identifier, and transmits the audio information to the server via a secure protocol.

The server receives the audio information and uses a speech recognition module to convert the audio information into language information. The speech recognition module may be implemented as a deep neural network based acoustic model and a language model executing on the server hardware or on a cloud speech-to-text service. For example, the acoustic model may be a multi-layer bidirectional recurrent neural network or a convolutional-recurrent architecture that outputs phoneme or character probabilities, while the language model may be a recurrent or transformer-based network that predicts word sequences. The server applies a decoding algorithm (e.g., beam search) to generate the most probable text sequence as the language information.

By performing the speech recognition using trained neural network models rather than simple keyword matching, the server improves recognition accuracy under noisy conditions and for varied phrasing, thereby improving the downstream intent analysis and reducing the frequency of correction requests. This improves the overall processing speed because fewer re-requests and confirmations are needed.

### C. Analysis of Language Information and Image Information

The server receives image information from the terminal when the terminal captures photographs or video frames using the camera. The server stores the image information as pixel matrices and transmits selected frames to an image analysis module.

The server analyzes the language information and the image information to extract feature information and request content. The server may use an intent classification model implemented as a neural network (for example, a feed-forward network or a transformer encoder) that takes tokenized language information as input and outputs a probability distribution over predefined intent categories (e.g., content recommendation, recipe suggestion, schedule inquiry, travel proposal).

The server uses a natural language processing library to perform tokenization, part-of-speech tagging, and named entity recognition to extract entities such as dates, times, locations, food types, and media categories from the language information. The server represents the extracted entities and intent as structured data, such as key-value pairs, and stores them in the internal information data.

The server applies an image analysis module, such as a convolutional neural network or a pre-trained visual feature extractor, to the image information. The server computes feature vectors for each frame and passes these through classification layers to identify objects or scenes (for example, a meal type, a product category, or a travel destination type). The server stores these classification results and any detected attributes as feature information. By computing these feature vectors and storing them in the internal information data, the server can later describe them explicitly as part of the prompt sentence.

This integration of language information and image information into a unified representation improves data management within the server; the server does not need to maintain separate pipelines for speech and image data. Instead, the internal information data acts as a normalized context container, reducing error-prone cross-module data conversions and improving computational efficiency.

### D. Estimation of Emotional State

The server estimates an emotional state of the user on the basis of at least one of the audio information and the language information. The server may compute acoustic features such as pitch, energy, zero-crossing rate, and spectral characteristics from the audio information and supply these features to an emotion estimation model. The emotion estimation model may be a neural network comprising convolutional layers for local temporal patterns and recurrent layers for longer temporal dependencies. The network outputs probability values for discrete emotion categories such as relaxed, tired, stressed, excited, or neutral.

In addition, or alternatively, the server may send the language information to a text-based tone analysis module, which uses a transformer-based classifier trained on labeled text samples with emotion or sentiment labels. This model outputs scores for categories such as joy, sadness, anger, confidence, and tentativeness.

The server optionally receives face-based emotion results from an external emotion recognition API, if the terminal captures the user's face and transmits the corresponding image information. The server then applies a fusion algorithm, such as a weighted averaging of probabilities or a simple Bayesian combination, to combine the voice-based, text-based, and face-based emotion estimates into a single emotional state included in the internal information data.

By using these neural network-based models and fusion strategies, the server derives a more robust emotional state with lower error than a simple threshold-based heuristic. This improved estimation accuracy causes improved prompt context and in turn more accurate and user-appropriate proposal information from the generative AI model.

### E. Generation of Internal Information Data

The server generates internal information data by combining the request content, feature information, emotional state, and user history information retrieved from storage. The server stores user history information in one or more databases. For example, the server may store prior recommendations, user selections, non-selections, and ratings in normalized relational tables. The server also stores content metadata, such as item identifiers, categories, run times, or preparation times, in separate tables.

The server constructs the internal information data as a structured record or object. The internal information data may include fields such as:
request_type (e.g., recipe, movie, schedule),
request_text (the original language information),
entities (e.g., “tomorrow,” “Japanese food,” “spicy”),
emotion_label (e.g., “tired”),
emotion_confidence,
visual_context (e.g., “user is viewing a product shelf,” “scene is a beach”),
history_summary (e.g., “user likes science-fiction movies and spicy dishes”),
constraints (e.g., “under 20 minutes,” “avoid dairy”).

By formalizing the internal information data in this way, the server explicitly separates the acquisition of context from its subsequent conversion into natural language. This structure allows the server to programmatically decide which elements to include in the prompt sentence under different conditions, improving control over the generative AI model and facilitating future extension to additional modalities.

F. Generation of Prompt Sentence and Interaction with Generative AI Model

The server converts the internal information data into a natural-language prompt sentence. The server uses a rule-based or template-based prompt construction module that receives the internal information data and outputs a text string. For example, the server may generate a prompt sentence in the following form:
“User profile: [history_summary].
Current request: ‘[request_text]’.
Current emotion: [emotion_label].
Task: [task_description with constraints].”

As specific examples, the server may generate prompt sentences such as:
“User profile: The user has highly rated several science-fiction and mystery movies and often watches complex, intellectually engaging films.
Current request: ‘What movie should I watch next?’.
Current emotion: relaxed.
Task: Based on the user's viewing history, recommend 3 to 5 movies that are intellectually engaging but not too heavy in mood. For each recommendation, output the title and a one-sentence explanation.”
or
“User profile: The user likes Japanese food, avoids dairy products, and usually chooses quick recipes on weekdays.
Current request: ‘Please suggest a recipe. I'm tired today.’
Current emotion: tired.
Task: Propose one dinner recipe that can be cooked in under 20 minutes, is easy to prepare after work, and uses common ingredients. Include a list of ingredients and simple step-by-step cooking instructions.”

The server supplies the prompt sentence to a generative AI model. The generative AI model may be implemented as a large-scale transformer network with multiple encoder-decoder layers, self-attention mechanisms, and feed-forward sublayers. The model has parameters (weights and biases) that have been trained on large text corpora through an unsupervised language modeling objective, such as minimizing the cross-entropy between predicted token probabilities and actual tokens in training sentences.

When processing the prompt sentence, the generative AI model tokenizes the text, embeds the tokens into high-dimensional vectors, applies a series of attention operations over the sequence, and produces a probability distribution over possible tokens for each step of the output sequence. The generative AI model then samples or selects tokens iteratively according to model parameters such as temperature and beam width, and returns generated text as proposal information.

This architecture differs from simple rule-based or template systems used by humans in that it leverages high-dimensional continuous representations and non-linear transformations to capture complex dependencies between user context and possible outputs. The server uses the model not merely as a text generator but as a context-conditioned proposal engine, where the prompt sentence controls the model's behavior in a structured way.

### G. Optimization Process and Ranking of Proposal Information

The server receives the proposal information from the generative AI model and parses it into structured data. For example, when the model outputs a list of recommendations, the server extracts the individual items, associated descriptions, and any attributes included in the generated text.

The server compares the proposal information with user history information and external information resources. The server may query external content catalogs, restaurant menus, schedule repositories, or other services to check real-time availability, locality constraints, or resource constraints. The server may also verify whether the items proposed by the model satisfy allergies, dietary restrictions, or time constraints.

The server applies an optimization process to select or rank the proposal information. The server may use a recommendation model implemented in a machine learning framework to compute a relevance score for each candidate. The recommendation model may be a neural network that takes as input feature vectors representing both the user and the candidate item (e.g., embeddings of past interactions, categorical features, numerical attributes). The server trains this model using historical interaction data and an objective function such as logistic loss or pairwise ranking loss, and updates its parameters through gradient-based optimization (e.g., stochastic gradient descent or adaptive methods).

The server applies non-conventional selection rules to ensure that items align with user constraints and model confidence. For example, the server may discard candidates whose predicted preference score falls below a learned threshold or whose required preparation time exceeds a threshold inferred from the user's typical behavior in similar emotional states. The server then sorts the remaining candidates according to their scores and selects top entries for presentation.

By performing this optimization process, the server reduces the burden placed on the generative AI model to produce perfectly filtered outputs and instead uses a computationally efficient, data-driven selection layer. This layered design yields improved accuracy and reduces unrealistic or inappropriate recommendations, which constitutes an improvement of computer-implemented recommendation technology over systems that rely solely on generative outputs without structured optimization.

H. Presentation Processing and Interaction with the Terminal

The server generates visual presentation information and acoustic presentation information based on the selected proposal information. The server formats the information into structured payloads suitable for the terminal. For visual presentation, the server may construct a list of items containing text labels, descriptions, associated icons or images retrieved from content repositories, and navigation identifiers. For acoustic presentation, the server composes a concise natural-language summary of the recommendations and passes this text to a text-to-speech service.

The text-to-speech service processes the input text using a sequence-to-sequence or vocoder-based neural network. The server receives the synthesized audio and packages it as acoustic presentation information. The server then transmits the visual presentation information and acoustic presentation information to the terminal.

The terminal receives the presentation information and renders it to the user. The terminal displays visual elements on the screen and plays the synthesized voice through the speaker. The user can then select one of the recommended items, request more details, or issue a new spoken request. The terminal transmits the user's selection as behavior history to the server for further learning.

By integrating the presentation processing and the selection feedback into the overall system, the server enables an interactive loop in which model outputs and user actions are tied together, supporting continuous improvement over time.

### I. Learning Optimization Process

The server stores selection information and non-selection information as behavior history. For each session, the server records which items were presented, which items the user selected, and which items the user ignored or rejected. The server associates this behavior history with the internal information data that produced the corresponding prompt sentence. The server periodically performs machine learning processing to update models and to adjust the internal information data elements and prompt sentence structure. The server may train a policy model that predicts which portions of the internal information data are most predictive of successful recommendations. For example, the server may train a model with input features corresponding to specific elements (e.g., emotion_label, history_summary granularity, or presence of visual_context) and an output reflecting user engagement or satisfaction metrics. The server may then adjust the prompting rules, such as including more detailed history or emphasizing emotion, when such inclusion improves predicted outcomes. During training, the server computes an error function, such as cross-entropy between predicted and actual user selections or a ranking loss, and updates model weights by backpropagation. The server may use data augmentation techniques, such as perturbing entity values or simulating alternative emotional states, to improve robustness of the models. Through this learning optimization process, the server gradually evolves its internal representation and prompt construction strategy. This is not a simple automation of human editing of prompts; rather, the server uses system-level performance feedback to tune which technical features (fields, attributes, and derived metrics) it passes into the generative AI model. As a result, the server reduces token usage in the prompt sentence, lowers communication overhead with the model, and improves the stability and relevance of generated outputs, which is a technical advantage in terms of computation and network resource usage.

### J. Schedule-Related Embodiment

In another embodiment, the server focuses on schedule-related requests. When the language information indicates a schedule-related query, the server accesses an external schedule management resource. The server retrieves schedule information such as appointments, reminders, and tasks. The server inserts summarized schedule information into the internal information data and generates a prompt sentence that includes both the schedule information and the emotional state of the user.

For example, the server may generate a prompt sentence such as:
“User schedule: Tomorrow the user has a meeting at 10:00, a medical appointment at 15:00, and a dinner at 19:00.
Current request: ‘Tell me tomorrow's schedule.’
Current emotion: stressed.
Task: Summarize the user's schedule for tomorrow in a concise and reassuring manner, emphasizing important appointments and suggesting an appropriate time window for rest.”

The server supplies this prompt sentence to the generative AI model and receives a natural-language summary as proposal information. The server may then optimize the summary for length and relevance, generate both visual and acoustic presentation information, and return the results to the terminal.

By integrating external schedule information and emotion into the unified prompt sentence and by applying optimization before output, the server improves the clarity and emotional appropriateness of schedule summaries beyond simple chronological listing. The system thus improves human-machine interaction by adjusting the presentation based on computationally derived user state, which is not readily achievable by manual scheduling methods.

### K. Technical Improvements and Alternative Embodiments

The described system improves computer technology itself in several ways. The use of internal information data as a unified structure reduces duplication of context handling logic and enables shared optimization across domains (e.g., media recommendation, recipe suggestion, and scheduling). This structural unification simplifies data flows inside the server, improves cache locality when accessing frequently used attributes, and reduces serialization overhead, thereby improving processing speed.

The server reduces communication load with external generative AI services by encoding only essential, pre-integrated context into a compact prompt sentence rather than transmitting raw logs or unfiltered sensor streams. The server further reduces computational waste by filtering and scoring proposals using specialized recommendation models, avoiding repeated full model calls in response to small user changes.

Additionally, by explicitly training models to predict which internal features and prompt structures yield successful results, the server improves the selection of prompt content, reducing unnecessary tokens and network traffic and shortening inference latency. These improvements are technical in nature and go beyond merely automating what a human operator could do; the system applies non-intuitive feature selection and model adaptation techniques that exploit large-scale behavior histories and high-dimensional representations.

In an alternative embodiment, the server may deploy the generative AI model locally rather than through a remote service, for example on a dedicated accelerator device such as a graphics processing unit. In this case, the same internal information data and prompt sentence structure are used, but the server can perform low-latency inference and further fine-tune the model on domain-specific corpora. The server may add adapter layers to the transformer network and train them using behavior history as supervision, thus further specializing the generative AI model to the particular application.

In another embodiment, the terminal may perform preliminary emotion estimation using on-device neural networks and send only the estimated emotional state to the server instead of raw audio. This reduces bandwidth consumption and latency while keeping the architecture of the internal information data and prompt sentence generation unchanged.

In another variation, the server may incorporate a rule-based validation module that checks generated proposal information against strict technical constraints, such as maximum caloric intake for a diet plan or conflict detection in schedule planning. This module operates after the generative AI model but before final optimization, ensuring that physically or logically impossible outputs are discarded.

Through these embodiments and variations, the system maintains the core concept of generating internal information data, constructing a context-rich prompt sentence, using a generative AI model to obtain proposal information, optimizing the proposal information using additional computational models and resources, and presenting the optimized results to the user through a terminal. The described architectures, data structures, and learning procedures enable practitioners to implement the claimed system and realize the technical benefits of improved accuracy, efficiency, and adaptability in multimodal, emotion-aware computer-implemented recommendation and schedule support.

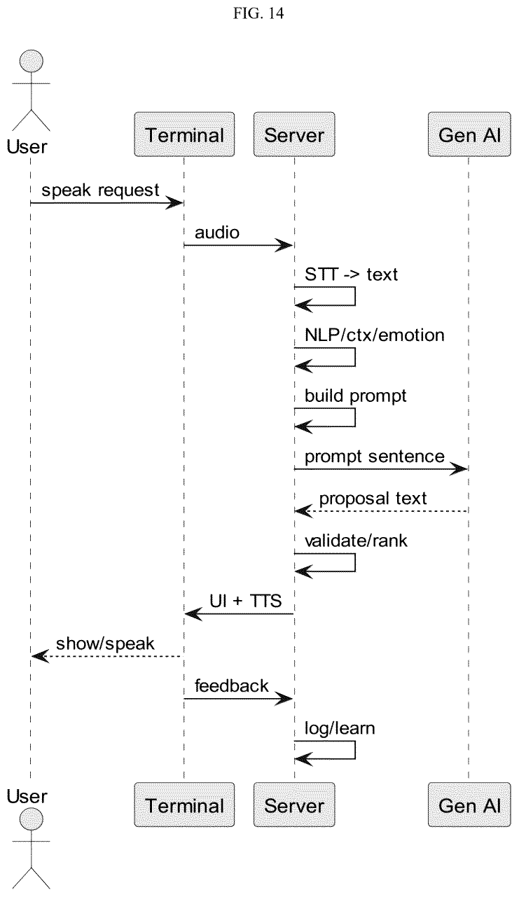

The following describes the processing flow using FIG. 14.

### Step 1:

User provides an utterance.

User speaks a request such as “What movie should I watch next?” or “Please suggest a recipe. I'm tired today.” toward the terminal.

Input: Natural human speech (analog sound waves).

Output: Air-borne audio signal received at the microphone of the terminal.

### Step 2:

Terminal captures and digitizes audio information.

Terminal activates the microphone, samples the analog sound at a predetermined sampling rate (for example, 16 kHz), converts the analog signal into digital samples through an analog-to-digital converter, and buffers the resulting audio information in memory. Terminal then encapsulates the audio samples into a standard audio format (for example, PCM data in a container) and associates metadata such as user identifier, language code, and timestamp.

Input: Analog sound waves produced by the user.

Output: Digital audio information with associated metadata stored in terminal memory.

### Step 3:

Terminal transmits audio information to the server.

Terminal establishes a secure communication channel, constructs a request message including the digital audio information and metadata, and sends the message to a predefined endpoint of the server via a network.

Input: Digital audio information and metadata stored in the terminal.

Output: Network message containing the audio information and metadata delivered to the server.

### Step 4:

Server receives audio information and performs speech-to-text conversion.

Server accepts the network message, authenticates the terminal, and extracts the digital audio information and metadata. Server passes the audio information to a speech recognition module, which may run locally or on an external speech recognition service. Server applies a neural network-based acoustic model and language model to compute probabilities of phonemes, characters, or words, and uses a decoding algorithm to generate the most likely text sequence as language information.

Input: Digital audio information and metadata from the terminal.

Output: Language information represented as a text string corresponding to the user's utterance.

### Step 5:

Server analyzes language information to determine request content and entities.

Server processes the language information using a natural language processing library and an intent classification model. Server tokenizes the text, performs part-of-speech tagging, and detects named entities such as dates, times, categories, and modifiers (e.g., “tired,” “tomorrow,” “movie,” “recipe,” “spicy”). Server applies an intent classifier to categorize the request (for example, movie recommendation, recipe suggestion, schedule inquiry).

Input: Language information as text generated in Step 4.

Output: Request content consisting of an intent label and a set of extracted entities describing constraints and parameters of the user's request.

### Step 6:

Terminal optionally captures image information and transmits it to the server.

Terminal acquires one or more frames from a camera, such as a scene image or the user's surroundings, and encodes the frames as image information. Terminal associates metadata such as time, location (if available), and user identifier, and sends the encoded image information to the server via the network.

Input: Light from the environment, captured as raw sensor data by the camera.

Output: Encoded image information with metadata transmitted to the server.

### Step 7:

Server analyzes image information to extract feature information.

Server receives the image information, decodes the frames, and feeds the pixel data to an image analysis module, such as a convolutional neural network. Server computes feature vectors for the images and passes them through classification or detection layers to identify objects, scenes, or relevant attributes (for example, “food plate,” “product shelf,” “beach scene”).

Input: Encoded image information from the terminal.

Output: Feature information containing identified categories, attributes, or scene types associated with the user context.

### Step 8:

Server estimates an emotional state of the user.

Server calculates acoustic features from the original digital audio information, such as pitch contour, energy envelope, and spectral coefficients, and passes these features to an emotion estimation model implemented as a neural network. Server may also supply the language information to a text-based emotion classifier. Server combines the outputs of these models to infer an emotional state label and confidence values (e.g., “tired,” “relaxed,” “stressed”).

Input: Digital audio information and language information associated with the user's utterance.

Output: Emotional state data indicating a classified emotion and corresponding scores.

### Step 9:

Server retrieves user history information from storage.

Server uses the user identifier from the metadata to query one or more databases storing past behaviors and preferences. Server loads records such as past recommendations, selected items, ignored items, ratings, and domain-specific histories (e.g., previously watched content, ordered dishes, scheduled events). Server summarizes this information into a compact representation suitable for inclusion in downstream processing.

Input: User identifier and access to user history databases.

Output: User history information summarizing relevant past behaviors and preferences.

### Step 10:

Server constructs internal information data.

Server creates a structured data object that aggregates the request content (intent and entities), the feature information, the emotional state, and the user history information. Server assigns each component to predefined fields (e.g., request_type, entities, emotion_label, visual_context, history_summary, constraints) and stores this object temporarily in memory.

Input: Request content from Step 5, feature information from Step 7, emotional state from Step 8, and user history information from Step 9.

Output: Internal information data representing a unified context for the current user request.

### Step 11:

Server generates a prompt sentence from the internal information data.

Server applies a prompt construction module that maps the internal information data into a natural-language prompt sentence. Server selects relevant fields (such as user preferences, emotional state, constraints, and the original request text), arranges them according to predetermined templates, and fills template placeholders with concrete values from the internal information data. For example, server may generate:
“User profile: The user likes Japanese food, avoids dairy products, and usually chooses quick recipes on weekdays.
Current request: ‘Please suggest a recipe. I'm tired today.’
Current emotion: tired.
Task: Propose one dinner recipe that can be cooked in under 20 minutes, is easy to prepare after work, and uses common ingredients. Include a list of ingredients and simple step-by-step cooking instructions.”

Input: Internal information data generated in Step 10.

Output: Prompt sentence in natural language describing the user profile, request, emotional state, and task constraints.

### Step 12:

Server sends the prompt sentence to a generative AI model and obtains proposal information. Server submits the prompt sentence as input to a generative AI model, such as a large transformer-based language model hosted locally or on a remote service. Server passes model parameters such as maximum output length and decoding strategy. The generative AI model encodes the prompt, computes context-dependent token probabilities over multiple attention layers, and generates text representing candidate solutions or recommendations. Server receives this generated text as proposal information.

Input: Prompt sentence created in Step 11.

Output: Proposal information in the form of generated text, such as recommended items, explanations, recipes, or summaries.

### Step 13:

Server parses and structures the proposal information.

Server analyzes the generated text using parsing rules or a lightweight information extraction routine to identify individual candidate items, labels, descriptions, and any auxiliary attributes indicated by the generative AI model. Server converts the unstructured text into a structured list of candidates with fields such as item_identifier (if available), title, description, and inferred attributes.

Input: Proposal information as generated text from Step 12.

Output: Structured proposal data comprising multiple candidate entries for further evaluation.

### Step 14:

Server validates proposal data against external information resources and user constraints. Server cross-checks each candidate item against external content catalogs, menus, schedule repositories, or other information resources by issuing database queries or API calls. Server verifies that each candidate satisfies technical and contextual constraints, such as availability, time requirements, dietary restrictions, or schedule conflicts. Server marks or removes candidates that fail validation.

Input: Structured proposal data from Step 13, user history information from Step 9, and external information resources accessible via the server.

Output: Filtered candidate set where invalid or conflicting proposals are removed or flagged.

### Step 15:

Server ranks and selects a subset of candidates in an optimization process. Server computes a relevance score for each remaining candidate using a recommendation model trained on behavior history. Server feeds feature vectors representing the user and each candidate into the recommendation model and obtains predicted preference values. Server sorts candidates according to these scores and selects a top subset suitable for presentation.

Input: Filtered candidate set from Step 14 and user behavior history embedded as model features.

Output: Ranked list of selected proposal items optimized for the current context and user profile.

### Step 16:

Server generates visual presentation information and acoustic presentation information. Server constructs visual presentation information by creating a data structure containing the selected candidates, each with display text, summary descriptions, and optional images or icons. Server also generates a concise natural-language explanation of the top candidates as text to be spoken. Server supplies this text to a text-to-speech service, which synthesizes digital audio signals representing spoken output, and the server packages the resulting audio data as acoustic presentation information.

Input: Ranked list of selected proposal items from Step 15.

Output: Visual presentation information formatted for display and acoustic presentation information in the form of synthesized audio data.

### Step 17:

Server transmits presentation information to the terminal.

Server encapsulates the visual presentation information and the acoustic presentation information into a response message, includes any necessary metadata for rendering (such as ordering and layout hints), and sends the response message back to the terminal over the network.

Input: Visual and acoustic presentation information generated in Step 16.

Output: Network response message containing presentation information delivered to the terminal.

### Step 18:

Terminal presents information to the user.

Terminal receives the response message, decodes the visual presentation information, and renders the recommended items and descriptions on the display in an appropriate layout.

Terminal also decodes the acoustic presentation information and plays the synthesized speech through the speaker.

Input: Response message with visual and acoustic presentation information from the server.

Output: Human-perceivable output in the form of on-screen displays and audible speech presented to the user.

### Step 19:

User reacts to the proposals and provides behavior feedback.

User selects one of the presented items, dismisses the proposals, or issues a follow-up request via touch, click, or additional speech.

Input: Presented visual and acoustic information from the terminal.

Output: User actions such as selections, non-selections, or new utterances.

### Step 20:

Terminal captures user behavior and sends feedback to the server.

Terminal detects the user's selection or lack of selection through the user interface or captures a new utterance via the microphone. Terminal records which proposal items were chosen, which were ignored, and any explicit rejection signals. Terminal then transmits this behavior data, along with identifiers for the presented items and session context, to the server.

Input: User interactions with the terminal UI and any new audio input.

Output: Behavior feedback data describing selection information and non-selection information sent to the server.

### Step 21:

Server logs behavior history and updates learning data.

Server receives the behavior feedback data and associates it with the corresponding internal information data and proposal information used in that session. Server stores this association in a behavior history log, including information about which prompt sentence led to which proposals and which items were ultimately selected. Server adds these records to the training data used for updating emotion models, recommendation models, and prompt construction policies.

Input: Behavior feedback data from Step 20 and session identifiers linking to internal information data and prompt sentences.

Output: Updated behavior history and training datasets stored in server-side storage.

### Step 22:

Server performs periodic learning optimization.

Server periodically retrieves accumulated behavior history, extracts training samples, and runs machine learning processing to adjust model parameters and prompt construction rules. Server computes error functions such as ranking loss or prediction error with respect to actual user selections, and updates model weights through gradient-based optimization. Server modifies which elements of the internal information data are included or emphasized in the prompt sentence based on learned importance, and updates thresholds and weights used in the optimization process.

Input: Behavior history and previously trained model parameters.

Output: Updated model parameters and revised prompt construction and optimization strategies, which are applied in subsequent executions of Steps 5 to 16.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

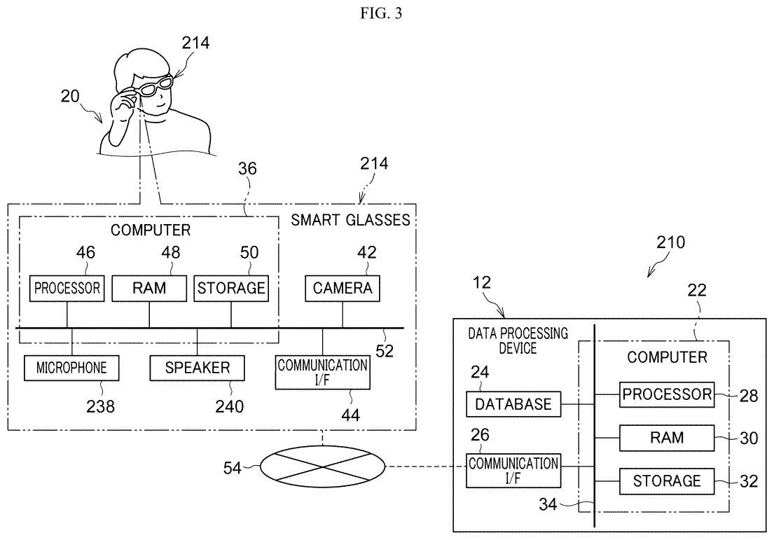

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

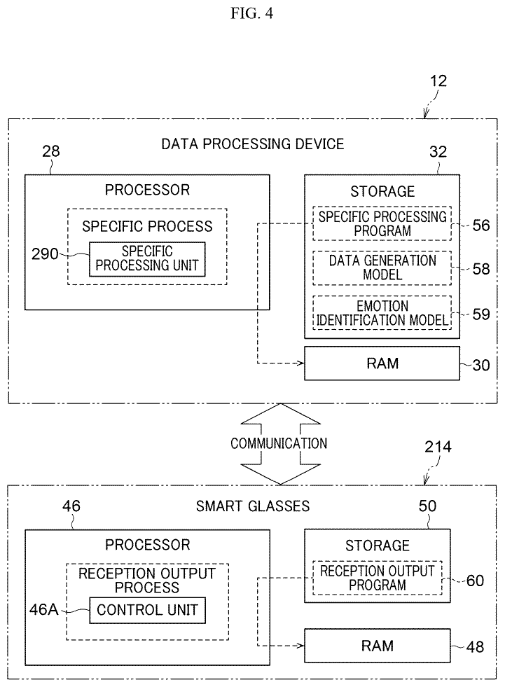

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

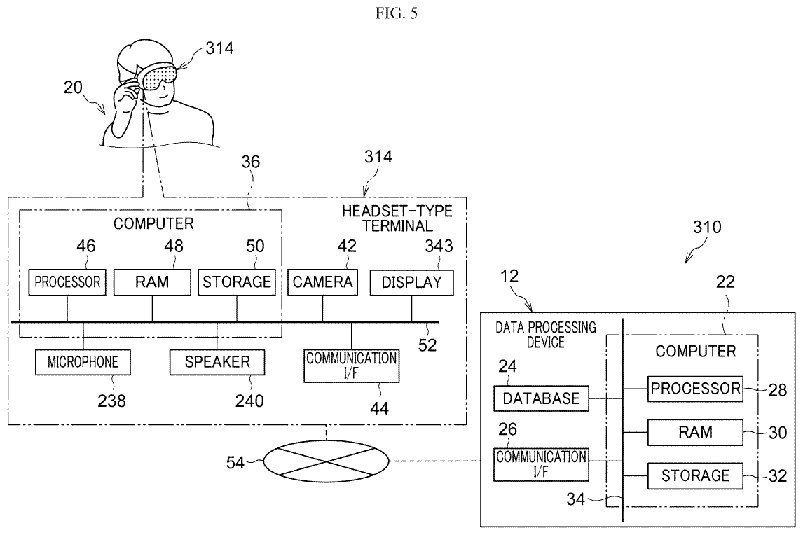

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

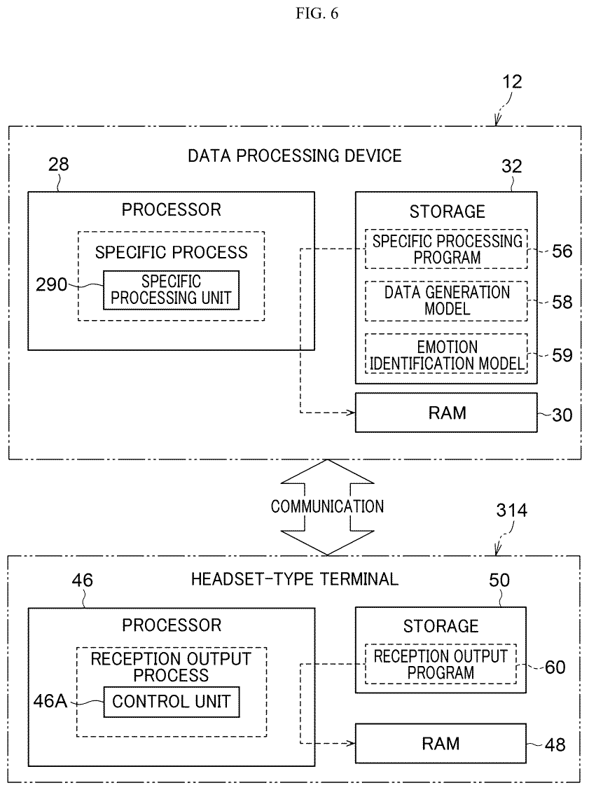

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

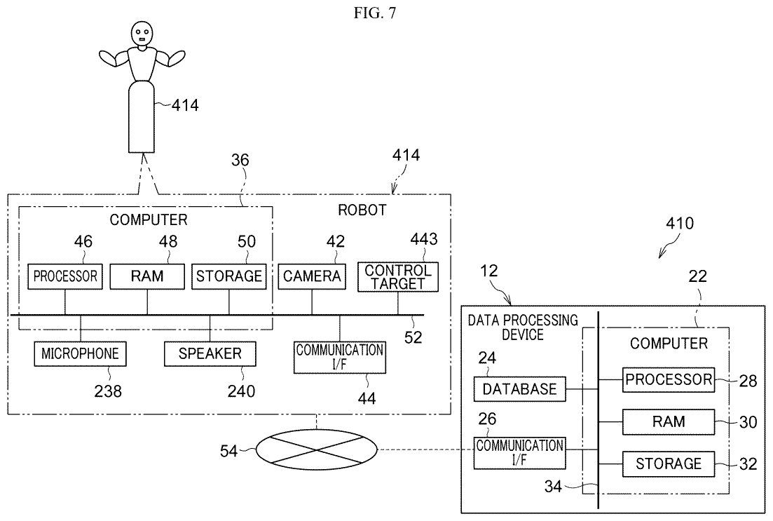

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

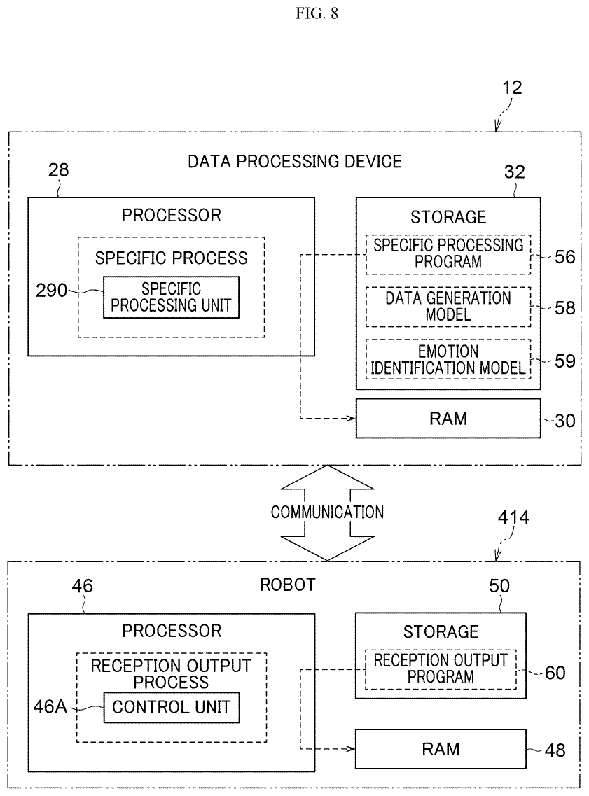

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

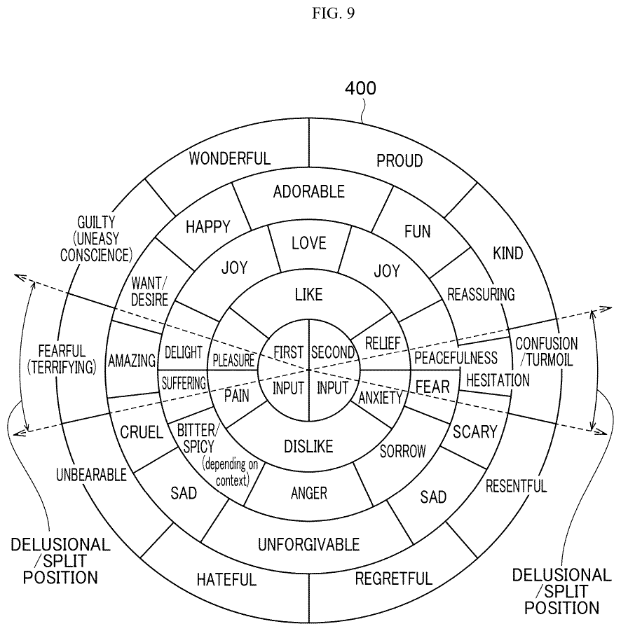

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

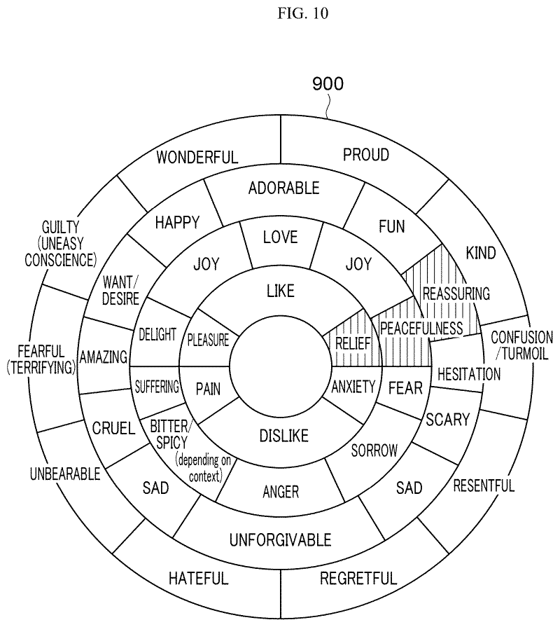

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, from a terminal, user voice information or character information, convert the user voice information into character information by using voice recognition processing and character string processing, and normalize and correct an error of the character information, analyze the character information and image information to extract intent information indicating a usage purpose and target information, and select at least one function from among a schedule management function, a movement plan presentation function, a meal proposal function, a character correction function, and an image analysis function based on the intent information,
generate and transmit inquiry data to an external information processing unit or an internal information processing unit according to the selected function, acquire processing result data including at least one of schedule information, movement information, meal information, character information, and image analysis information, and aggregate the processing result data into structured data of a predetermined format,
generate a prompt sentence to be input to a generative artificial intelligence model based on a user request content and the structured data, transmit the prompt sentence to a generative AI model, and acquire a response sentence expressed in natural language from the generative AI model,
generate output information for the terminal based on the response sentence, and transmit at least one of display information and voice synthesis information to the terminal, and store evaluation information and response history information obtained from a user as learning data, and update at least one of processing of determining the intent information and processing of selecting the function based on the learning data.

### (Supplementary 2)

The system according to supplementary 1,
wherein the processor is configured to
configure the prompt sentence so as to include the user request content, the structured data, and instruction information regarding a response style, and monitor length, expression, and content of the response sentence obtained from the generative AI model based on monitoring information, and generate, when necessary, an additional prompt sentence for regeneration.

### (Supplementary 3)

The system according to supplementary 1,
wherein the processor is configured to
receive, from the terminal, evaluation operation information and additional comment information for the response sentence as the learning data, and reset at least a part of processing of determining the intent information, processing of selecting the function, and processing of generating the prompt sentence based on the learning data.

### Application Example 1

### (Supplementary 1)

A system comprising a processor,
wherein the processor is configured to
acquire audio information from a user and convert the audio information into character information by natural language processing,
acquire image information or video information and convert the image information or the video information into feature information and recognized character information by image analysis,
acquire past selection history information and behavior history information from a storage unit based on user identification information and generate user preference information by performing statistical processing and feature extraction processing on the acquired history information,
calculate, based on the user preference information, the character information, and the feature information, an evaluation value for each candidate item by using a machine learning model, and select at least one candidate item based on the evaluation value,
generate, based on the user preference information, the at least one candidate item, the evaluation value, the character information, and the feature information, a prompt sentence to be input to a generative artificial intelligence model, and transmit the prompt sentence to the generative artificial intelligence model,
generate, based on response information acquired from the generative artificial intelligence model, explanation information or proposal information regarding the at least one candidate item, and transmit the explanation information or the proposal information as output information to a terminal device, and
record, in the storage unit, final selection information of the user transmitted from the terminal device, and update the past selection history information based on the final selection information.

### (Supplementary 2)

The system according to supplementary 1,
wherein the processor is configured to
train the machine learning model based on the evaluation value of the at least one candidate item and the final selection information, and adaptively update processing for generating the user preference information and for calculating the evaluation value.

### (Supplementary 3)

The system according to supplementary 1,
wherein the processor is configured to
extract schedule information from the character information, register the schedule information in a schedule management storage area, generate, by transmitting to the generative artificial intelligence model a prompt sentence including the schedule information, a notification text, and output reminder information to the terminal device based on the notification text.

### Example 2

### (Supplementary 1)

A system comprising a processor,
wherein the processor is configured to
receive, via a terminal device, voice input from a user and convert the voice input into character information by performing speech recognition processing,
perform natural language processing on the character information to extract an intention of the user and, based on the intention, select, from among a plurality of function modules, at least a schedule management function module and a proposal generation function module,
when the schedule management function module is selected, acquire record information associated with the user from a storage device and extract schedule information based on time information included in the record information,
when the proposal generation function module is selected, acquire history information and attribute information associated with the user from the storage device and generate structured data including the history information and the attribute information,
generate a prompt sentence including at least one of the schedule information and the structured data, the intention of the user, and an instruction regarding a response format, and input the prompt sentence into a generative AI model to cause the generative AI model to generate response information expressed in natural language, and
execute speech synthesis processing based on the response information, generate audio data, and transmit the audio data to the terminal device to present the audio data to the user.

### (Supplementary 2)

The system according to supplementary 1,
wherein the processor is configured to
change, in a dynamic manner, components, output conditions, and expression styles of the prompt sentence in accordance with a learning result obtained by learning behavior history information and usage tendency information of the user, so as to optimize content and a presentation method of the response information generated by the generative AI model.

### (Supplementary 3)

The system according to supplementary 1,
wherein the processor is configured to
specify a target period based on a time expression extracted by the natural language processing, extract the record information corresponding to the target period as the schedule information, and cause the prompt sentence to include the schedule information as structured data for summary explanation, thereby causing the generative AI model to generate a summary explanation of the schedule and reminder content.

### Application Example 2

### (Supplementary 1)

A system comprising a processor,
wherein the processor is configured to
acquire audio information and perform a conversion process for converting the audio information into language information,
analyze the language information and image information to extract feature information regarding an object or a situation from the image information and to extract a request content of a user from the language information,
estimate an emotional state of the user on the basis of at least one of the audio information and the language information by performing an emotion estimation process,
generate internal information data including at least the request content, the feature information, the emotional state, and history information of the user, and generate a prompt sentence describing the internal information data in natural language by performing a prompt sentence generation process,
input the prompt sentence into a generative AI model and acquire proposal information from the generative AI model by performing a generation process,
compare the proposal information with the history information and with external information resources and perform an optimization process for selecting or ranking the proposal information, and
generate visual presentation information or acoustic presentation information on the basis of a result of the optimization process and present the visual presentation information or the acoustic presentation information to the user by performing a presentation process.

### (Supplementary 2)

The system according to supplementary 1,
wherein the processor is configured to
store selection information or non-selection information of the proposal information by the user as behavior history, learn the behavior history by machine learning processing, and update at least one of elements included in the internal information data and description contents of the prompt sentence on the basis of a result of the learning as a learning optimization process.

### (Supplementary 3)

The system according to supplementary 1,
wherein the processor is configured to
extract, from the language information, a request related to a schedule, cooperate with an external schedule management resource to acquire or update schedule information, and, in the prompt sentence generation process, generate the prompt sentence including at least one of a summary of the schedule information and proposal content based on the schedule information and the emotional state.

What is claimed is:

1. A system comprising:
circuitry configured to:
receive, via a communication interface coupled to a packet-switched network, audio information or character information from a terminal device of a user, and convert the audio information into character information using natural language processing including speech recognition processing and character string processing;
receive image information or video information from the terminal device and apply image analysis processing to extract feature information and recognized character information from the image information or the video information;
acquire past selection history information and behavior history information from a storage device based on user identification information, and generate user preference information by performing statistical processing and feature extraction processing on the acquired history information;
calculate, based on the user preference information, the character information, and the feature information, an evaluation value for each of a plurality of candidate items using a machine learning model, and select at least one candidate item based on the evaluation value;
generate a prompt sentence based on the user preference information, the at least one candidate item, the evaluation value, the character information, and the feature information, transmit the prompt sentence to a generative neural network model, and receive response information from the generative neural network model;
transmit, via the communication interface, output information based on the response information to the terminal device; and
record, in the storage device, final selection information transmitted from the terminal device, and update the past selection history information and the behavior history information based on the final selection information.

2. The system according to claim 1, wherein the circuitry is configured to normalize and correct the character information by applying character string processing comprising at least one of character type unification, case standardization, punctuation normalization, and grammar error correction prior to generating the prompt sentence.

3. The system according to claim 2, wherein the circuitry is configured to perform intent analysis on the normalized character information using an intent classification model to generate intent information indicating a usage purpose of the user request, and to perform entity extraction to generate target information indicating entities and parameters relevant to the intent information.

4. The system according to claim 3, wherein the circuitry is configured to select at least one functional module from a plurality of functional modules based on the intent information, the plurality of functional modules comprising at least one of a schedule management function, a movement plan presentation function, a meal proposal function, a character correction function, and an image analysis function.

5. The system according to claim 4, wherein the circuitry is configured to generate inquiry data based on the selected functional module and the target information, transmit the inquiry data to at least one of an external information processing unit or an internal information processing unit, receive processing result data, and aggregate the processing result data into structured data of a predetermined format prior to constructing the prompt sentence.

6. The system according to claim 1, wherein the circuitry is configured to compute the evaluation value by encoding the user preference information and the feature information as numerical feature vectors and applying the machine learning model comprising a neural network having a plurality of fully connected layers with nonlinear activation functions to compute a relevance score for each candidate item.

7. The system according to claim 6, wherein the circuitry is configured to update parameters of the machine learning model by constructing training data from the past selection history information and the final selection information, and applying an optimization algorithm to minimize a loss function computed over batches of historical user-item interactions.

8. The system according to claim 1, wherein the circuitry is configured to generate the prompt sentence by combining user request content derived from the character information with structured data representing the at least one candidate item, the evaluation value, and the user preference information, and appending output format constraints specifying a desired style, length, and language of the response information.

9. The system according to claim 8, wherein the circuitry is configured to validate the response information received from the generative neural network model against content requirements and, when the response information fails to satisfy at least one content requirement, construct an additional prompt sentence comprising correction instructions and retransmit the additional prompt sentence to the generative neural network model.

10. The system according to claim 1, wherein the circuitry is configured to extract schedule information from the character information, register the schedule information in a schedule management storage area of the storage device, and generate reminder information by constructing a prompt sentence including the schedule information and transmitting the prompt sentence to the generative neural network model to obtain a notification text.

11. The system according to claim 10, wherein the circuitry is configured to determine a notification timing for the reminder information based on at least one of the schedule information and an estimated emotional state of the user derived from at least one of the audio information or interaction pattern data received from the terminal device.

12. The system according to claim 1, wherein the circuitry is configured to generate the user preference information by computing occurrence frequency metrics and co-occurrence statistics over the past selection history information and the behavior history information, and applying feature extraction processing to derive a user feature vector encoding at least one of style preferences, activity tendencies, or temporal usage patterns.

13. The system according to claim 12, wherein the circuitry is configured to update the user preference information at predetermined intervals by re-executing the statistical processing and feature extraction processing on updated history information comprising new entries accumulated from subsequent user interactions.

14. The system according to claim 1, wherein the circuitry is configured to store evaluation information and response history information obtained from the user as learning data, and to update at least one of processing parameters used in determining the intent information or processing parameters used in selecting the functional module based on the learning data.

15. The system according to claim 1, wherein the circuitry is configured to generate the output information in at least two formats comprising display information for visual presentation and voice synthesis information for audible presentation, and to select a presentation format based on capability information of the terminal device received via the communication interface.

16. The system according to claim 1, wherein the circuitry is configured to estimate an emotional state of the user based on at least one of acoustic features extracted from the audio information, facial expression information extracted from the image information, or linguistic sentiment derived from the character information, and to adjust at least one of a tone parameter or an expression parameter of the prompt sentence based on the estimated emotional state.

17. The system according to claim 1, wherein the circuitry is configured to monitor a processing latency of responses from the generative neural network model and, when the processing latency exceeds a threshold value, switch from a first generative neural network model having a higher parameter count to a second generative neural network model having a lower parameter count.

18. A system comprising:
circuitry configured to:
receive, via a communication interface coupled to a packet-switched network, audio information from a terminal device, and convert the audio information into character information using a speech recognition engine comprising an acoustic model and a language model;
receive image information from the terminal device and apply image analysis processing to extract feature information comprising at least one of detected object labels, scene classifications, or recognized text from the image information;
acquire past selection history information and behavior history information from a storage device based on user identification information, and generate user preference information by performing statistical processing and feature extraction processing on the acquired history information;
calculate an evaluation value for each of a plurality of candidate items by applying a machine learning model to a feature vector encoding the user preference information, the character information, and the feature information, and select at least one candidate item based on the evaluation value;
generate a prompt sentence combining user request content with the at least one candidate item, the evaluation value, and the user preference information, transmit the prompt sentence to a generative neural network model, and receive response information; and
transmit output information based on the response information to the terminal device via the communication interface, and record final selection information received from the terminal device in the storage device to update the past selection history information.

19. The system according to claim 18, wherein the circuitry is configured to extract schedule information from the character information, register the schedule information in a schedule management storage area of the storage device, and generate reminder information by constructing a prompt sentence including the schedule information and transmitting the prompt sentence to the generative neural network model.

20. A method comprising:
receiving, via a communication interface coupled to a packet-switched network, audio information or character information from a terminal device of a user, and converting the audio information into character information using natural language processing including speech recognition processing and character string processing;
receiving image information or video information from the terminal device and applying image analysis processing to extract feature information and recognized character information from the image information or the video information;
acquiring past selection history information and behavior history information from a storage device based on user identification information, and generating user preference information by performing statistical processing and feature extraction processing on the acquired history information;
calculating, based on the user preference information, the character information, and the feature information, an evaluation value for each of a plurality of candidate items using a machine learning model, and selecting at least one candidate item based on the evaluation value;
generating a prompt sentence based on the user preference information, the at least one candidate item, the evaluation value, the character information, and the feature information, transmitting the prompt sentence to a generative neural network model, and receiving response information from the generative neural network model;
transmitting, via the communication interface, output information based on the response information to the terminal device; and
recording, in the storage device, final selection information transmitted from the terminal device, and updating the past selection history information and the behavior history information based on the final selection information.
